(19) United States
(12) Patent Application Publication
(10) Pub. No.: US 2026/0261883 A1
(43) Pub. Date: Sep. 3, 2026

(54) COMMUNICATION APPARATUS AND COMMUNICATION METHOD FOR TUNNELED SENSING BY PROXY

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP); Rajat PUSHKARNA, Singapore (SG)

(21) Appl. No.: 18/993,318

(22) PCT Filed: Jul. 25, 2023
(86) PCT No.: PCT/SG2023/050518

§ 371 Date: Jan. 10, 2025

(30) Foreign Application Priority Data
Jul. 29, 2022 (SG) 10202250635E

(51) Int. Cl. H04W 24/08; H04W 76/10

(52) U.S. Cl. CPC H04W 24/08; H04W 76/10

(57) ABSTRACT

Communication devices and methods for tunneled sensing by proxy are provided. One exemplary embodiment provides a first communication apparatus comprising: circuitry, which in operation, generates a request frame to request a second communication apparatus to perform a measurement on one or more links of the second communication apparatus, each of the one or more links being attached to one or more third communication apparatuses; a transmitter, which in operation, transmits the request frame to the second communication apparatus; and a receiver, which in operation, receives a report frame from the second communication apparatus carrying one or more reports of the measurement respectively corresponding to the one or more links, wherein a frame body of the request frame is carried in a payload field of a first data frame, and a frame body of the report frame is carried in a payload field of a second data frame.

### TECHNICAL FIELD

The present disclosure generally relates to communication methods and apparatuses, and more particularly relates to methods and apparatuses for tunneled sensing by proxy.

### BACKGROUND

A wireless local area network (WLAN) sensing is under development by Institute of Electrical and Electronics Engineers (IEEE) 802.11bf Task Group. In the task group, Sensing by Proxy (SBP), which enables a client to obtain sensing measurement via a proxy device, is proposed, but the details of the protocol/procedure to select best links/STAs for the SBP procedure has not been discussed in the Task Group.

However, there is limited discussion on communication apparatuses and methods for sensing by proxy in connected wireless networks or sensing by proxy in legacy wireless networks.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for tunneled sensing by proxy.

According to an aspect of the present disclosure, there is provided a first communication apparatus comprising: circuitry, which in operation, generates a request frame to request a second communication apparatus to perform a measurement on one or more links of the second communication apparatus, each of the one or more links being attached to one or more third communication apparatuses; a transmitter, which in operation, transmits the request frame to the second communication apparatus; and a receiver, which in operation, receives a report frame from the second communication apparatus carrying one or more reports of the measurement respectively corresponding to the one or more links, wherein a frame body of the request frame is carried in a payload field of a first data frame, and a frame body of the report frame is carried in a payload field of a second data frame.

According to another aspect of the present disclosure, there is provided a second communication apparatus, comprising: a receiver, which in operation, receives a request frame from a first communication apparatus to perform a measurement on one or more links of the second communication apparatus, the one or more links being attached to one or more third communication apparatuses; circuitry, which in operation, performs the measurement; and a transmitter, which in operation, transmits a report frame carrying one or more reports of the measurement corresponding to the one or more links, wherein a frame body of the request frame is carried in a payload field of a first data frame, and a frame body of the report frame is carried in a payload field of a second data frame.

According to another aspect of the present disclosure, there is provided a communication method comprising: generating, by a first communication apparatus, a request frame to request a second communication apparatus to perform a measurement on one or more links of the second communication apparatus, each of the one or more links being attached to one or more third communication apparatuses; transmitting the request frame to the second communication apparatus; and receiving a report frame from the second communication apparatus carrying one or more reports of the measurement respectively corresponding to the one or more links, wherein a frame body of the request frame is carried in a payload field of a first data frame, and a frame body of the report frame is carried in a payload field of a second data frame.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts a schematic diagram illustrating a single-user (SU) communication between an access point (AP) and a station (STA) in a MIMO (multiple-input multiple-output) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 depicts a schematic diagram illustrating communications between a STA and an AP for a basic Sensing By Proxy (SBP) procedure.

FIG. 5 shows a schematic diagram illustrating communications in an exemplary extended SBP procedure.

FIG. 6 shows a schematic diagram illustrating communications in an alternative exemplary extended SBP procedure.

FIG. 7 shows a schematic diagram illustrating communications in a SBP procedure according to an example of the present disclosure.

FIG. 8 shows a schematic diagram illustrating communications in an exemplary SBP procedure according to various embodiments of the present disclosure.

FIG. 9A depicts an illustration of an exemplary SBP Ethertype 89-0d Data frame according to various embodiments of the present disclosure.

FIG. 9B depicts an illustration of an exemplary 1905.1 message according to various embodiments of the present disclosure.

FIG. 10 shows an exemplary flowchart illustrating an overview of a SBP procedure between two APs and three non-AP STAs according to various embodiments of the present disclosure.

FIG. 11 shows an exemplary flowchart illustrating a signaling overview of a SBP procedure between two APs and three non-AP STAs according to various embodiments of the present disclosure.

FIG. 12A depicts exemplary structures of SBP Request frame and SBP Response frame according to various embodiments of the present disclosure.

FIG. 12B depicts exemplary structures of Protected SBP Request frame and Protected SBP Response frame according to various embodiments of the present disclosure.

FIG. 13 depicts an example illustration of a SBP Parameters element according to various embodiments of the present disclosure.

FIG. 14 depicts an example illustration of a SBP Link Info element according to various embodiments of the present disclosure.

FIG. 15A depicts an example illustration of a Protected SBP Report frame according to various embodiments of the present disclosure.

FIG. 15B depicts an alternate example illustration of a Protected SBP Report frame according to various embodiments of the present disclosure.

FIG. 16 depicts exemplary structures of SBP Termination frame and Protected SBP Termination frame according to various embodiments of the present disclosure.

FIG. 17 depicts exemplary structures of Protected Authorization Validation Request frame and Protected Authorization Validation Response frame according to various embodiments of the present disclosure.

FIG. 18 illustrates communications in a variation of a SBP procedure according to various embodiments of the present disclosure.

FIG. 19 shows an exemplary flowchart illustrating an overview of a SBP procedure between three APs and four non-AP STAs according to various embodiments of the present disclosure.

FIG. 20 shows an exemplary flowchart illustrating a signaling overview of a SBP procedure between three APs and four non-AP STAs according to various embodiments of the present disclosure.

FIG. 21 depicts an exemplary 1905.1 Message Type according to various embodiments of the present disclosure.

FIG. 22 illustrates communications in a SBP procedure in which the SBP responder is a non-AP STA or a non-AP MLD according to various embodiments of the present disclosure.

FIG. 23 depicts an example illustration of an Extended Capabilities Element according to various embodiments of the present disclosure.

FIG. 24 shows an exemplary flowchart illustrating an overview of a SBP procedure between two APs and three non-AP STAs according to various embodiments of the present disclosure.

FIG. 25 shows an exemplary flowchart illustrating a signaling overview of a SBP procedure between two APs and three non-AP STAs according to various embodiments of the present disclosure.

FIG. 26 depicts an example illustration of a Sensing Measurement Instance according to various embodiments of the present disclosure.

FIG. 27 depicts communications in a SBP procedure in which the 1905.1 SBP messages are used to encapsulate SBP frames according to various embodiments of the present disclosure.

FIG. 28A depicts an alternate example illustration of a Protected SBP Report frame according to various embodiments of the present disclosure.

FIG. 28B depicts an example illustration of a Sensing Report Trigger frame according to various embodiments of the present disclosure.

FIG. 29 shows an exemplary flowchart illustrating an overview of a SBP procedure between three APs and three non-AP STAs according to various embodiments of the present disclosure.

FIG. 30A depicts an example illustration of a SBP Acknowledgement (Ack) frame and a Protected SBP Ack frame according to various embodiments of the present disclosure.

FIG. 30B depicts an example illustration of a Protected SBP Report Request frame according to various embodiments of the present disclosure.

FIG. 31 shows an exemplary flowchart illustrating an overview of a SBP procedure between three APs and three non-AP STAs in which SBP Ack is utilized according to various embodiments of the present disclosure.

FIG. 32 depicts an example configuration of a non-AP apparatus suitable for sensing and communication in accordance with various embodiments of the present disclosure.

FIG. 33 depicts another example configuration of a non-AP apparatus suitable for sensing and communication in accordance with various embodiments of the present disclosure.

FIG. 34 depicts an example configuration of an AP apparatus suitable for sensing and communication in accordance with various embodiments of the present disclosure.

FIG. 35 shows a flow diagram illustrating a method for tunneled sensing by proxy according to various embodiments of the present disclosure.

FIG. 36 shows a schematic, partially sectioned view of a STA that can be implemented for tunneled sensing by proxy in accordance with various embodiments of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. There is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for sensing by proxy, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

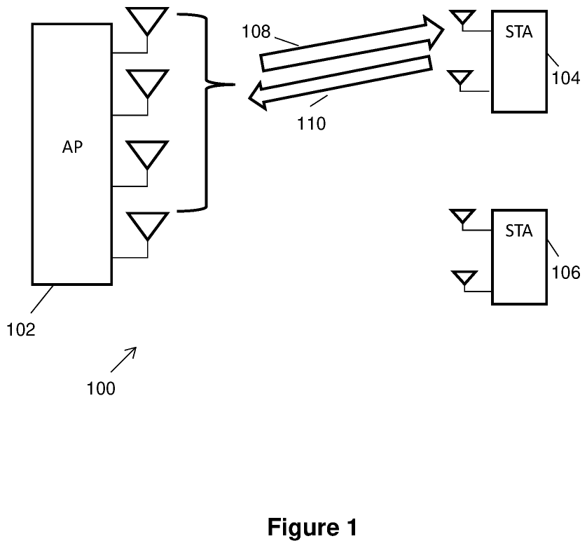

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e., the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

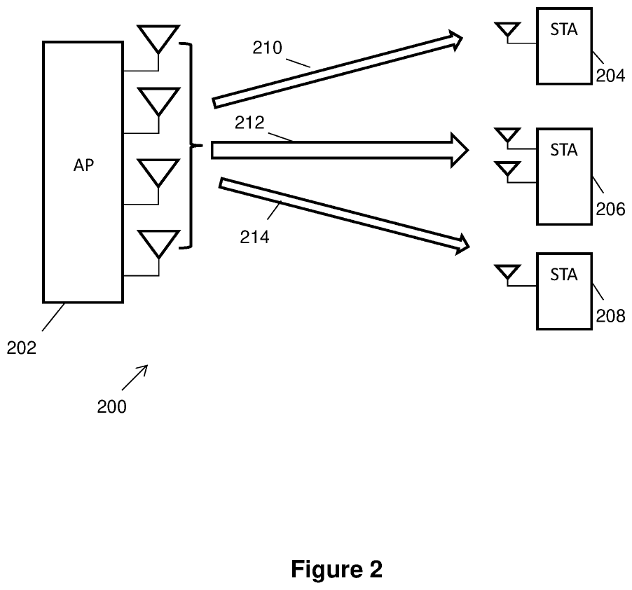

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (Rus) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) for the OFDMA or MU-MIMO communication occupies whole channel bandwidth, the OFDMA or MU-MIMO communications is called full bandwidth OFDMA or MU-MIMO communications. If the RU(s) for the OFDMA or MU-MIMO communication occupies a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

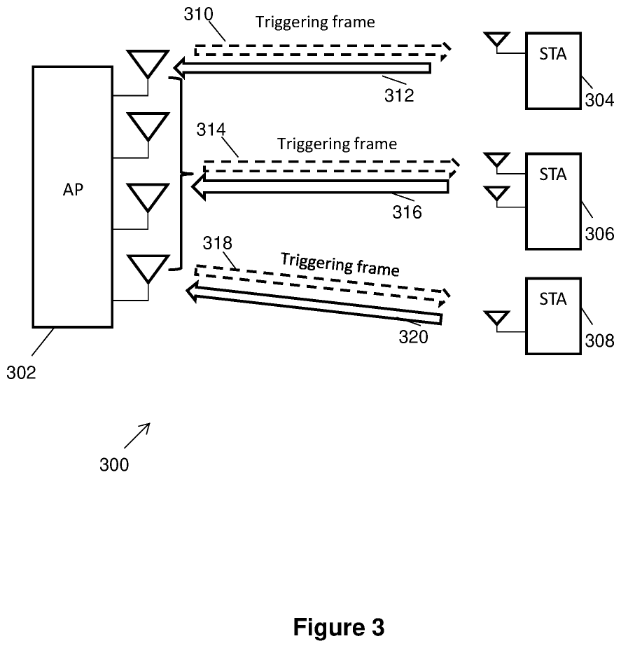

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated Rus) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission and distributed MAC (medium access control) scheme in 802.11 WLAN, time scheduling (e.g., TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, WLAN supports non-trigger-based communications as illustrated in FIGS. 1 and 2 and trigger-based communications as illustrated in FIG. 3. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

According to the present disclosure, the term “sensing initiator” refers to a device which initiates a sensing measurement with a STA (herein referred to as “client”) and requests for a sensing result from the STA. The term “sensing responder” is a STA which responds to the sensing initiator and participates in the sensing measurement. In various embodiments below, unless otherwise stated, the term “initiator” and “responder” refer to as “sensing initiator” and “sensing responder”, respectively. Typically (e.g., in Trigger Based (TB) sensing measurements), the initiator is an AP, while the responders are non-AP STAs; however, this need not always be the case and at times non-AP STAs can also be the initiator, and an AP can be a responder (e.g., in Non-TB sensing measurements, or Fine Timing Measurements (FTM)/Ranging).

In contrast to “sensing initiator” and “sensing responder”, the term “Sensing By Proxy (SBP) initiator” refers to a STA which initiates an SBP procedure and requests a device (e.g., AP or sensing initiator) to be a proxy sensing initiator to initiate a sensing session and requests for a sensing result from another STA (e.g., the device's client) on its behalf. The term “SBP responder” refers to a device which responds to the SBP initiator and agrees to participate in the SBP procedure to be a proxy sensing initiator. It is noted that an SBP initiator can be a sensing responder or one of multiple sensing responders of an SBP responder (sensing initiator).

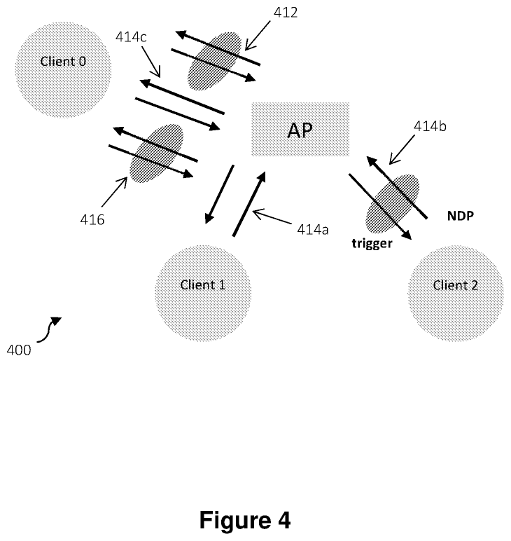

As mentioned earlier, SBP, which enables a client to obtain sensing measurement using multiple radio links, is introduced in IEEE 802.11 bf. FIG. 4 depicts a schematic diagram 400 illustrating communications between a STA (client 0) and an AP for a basic SBP procedure. According to the basic concept, a Sensing by Proxy procedure includes an SBP procedure setup, a sensing measurement, an SBP procedure reporting and an SBP procedure termination. During SBP procedure setup, a client (e.g., client 0) requests the AP to obtain sensing measurements with other clients (e.g., clients 1 and 2). The AP is configured to act as a proxy-initiator for the requesting client. In various embodiments illustrated in the present disclosure, such requesting client is referred to as SBP requesting STA or SBP Initiator while the AP is referred to proxy AP or SBP Responder. The proxy is established by exchanging SBP request/response frames 412 between the SBP Initiator and the SBP Responder. The AP then performs sensing measurement with one or more clients (e.g., clients 1 and 2), for example, by exchanging measurement setup request/response frames to establish sessions and/or measurement report frame 414a, 414b during measurement instance(s). In the FIG. 4 example, the SBP Initiator is one of the clients, and the AP may also perform sensing measurement with the SBP Initiator by exchanging the relevant frames 414c. During SBP procedure Reporting, the AP which obtained the client's measurement reports then reports them to the SBP Initiator, for example, by sending an SBP report frame 416. After the SBP procedure Reporting, the SBP procedure may be terminated at any time by either the SBP Initiator or the SBP Responder by transmitting an SBP Termination frame (not shown).

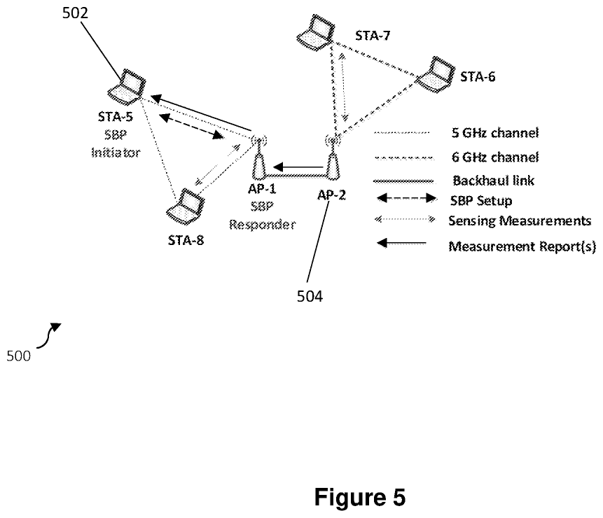

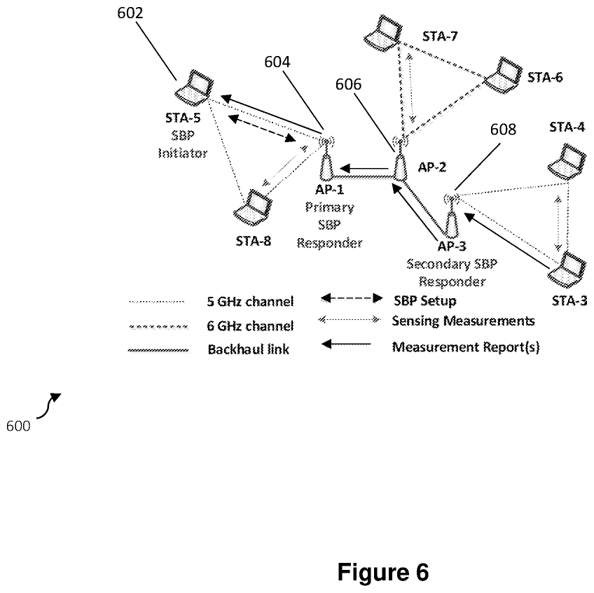

The above 11bf SBP procedure may be extended as shown in illustrations 500 and 600 of FIG. 5 and FIG. 6 respectively. For example, in illustration 500, it is possible to enable an SBP Initiator 502 to obtain sensing measurements from an AP (e.g., AP-2 504) with which it does not have a direct Wireless Medium (WM) connection. Further, in illustration 600, it is possible to enable an SBP Initiator 602 to obtain sensing measurements from multiple APs (e.g., AP-1 604 as a primary SBP Responder, AP-2 606 and AP-3 608 as secondary SBP Responders) acting as proxies for it in a single SBP procedure. These examples are based on the assumptions that all the APs are SBP capable, and proxies for SBP are always AP(s).

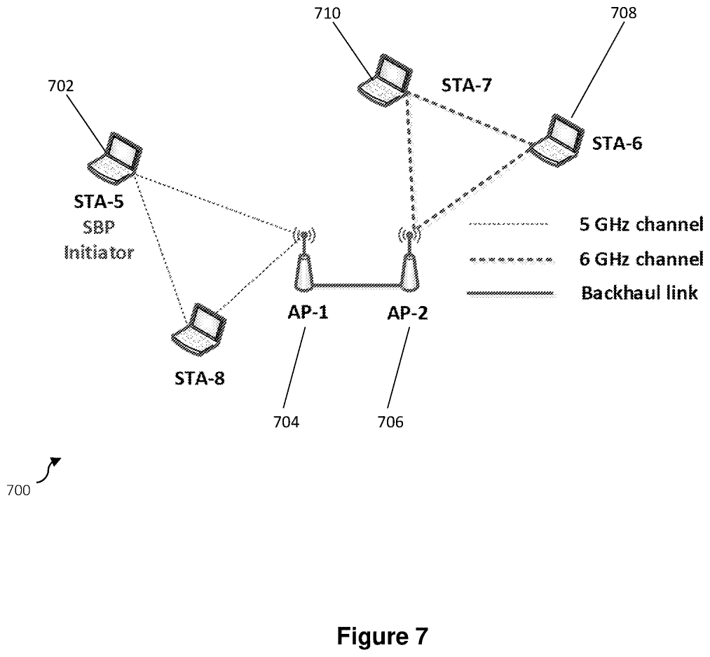

In the present disclosure, embodiments are provided to enable SBP even when one or more intermediate APs do not support SBP. For example, referring to illustration 700 of FIG. 7 in a first scenario, the SBP Initiator (e.g., STA-5 702) is in range of AP(s) that are not SBP capable (e.g., AP-1 704) but is out of range of SBP capable APs (e.g., AP-2 706). AP-1 704 may not even be 11bf capable (e.g., it may be a legacy AP). In a second scenario, none of the APs (e.g., AP-1 704, AP-2 706) may be SBP capable, but their associated non-AP STAs (e.g., STA-6 708, STA-7 710) are 11bf capable. Furthermore, the APs may not even be 11bf capable (e.g., they may be legacy APs). The APs and non-AP STAs may be standalone APs/STAs or may be affiliated with MLDs. BSS-1 (AP-1 and associated non-AP STAs STA-5 & STA-8) and BSS-2 (AP-2 and associated non-AP STAs STA-6 & STA-7) may be in different locations (e.g., in different rooms/floors etc.). To enable SBP for these scenarios, the SBP frames may be encapsulated in Data frames (by the SBP Initiator and the SBP Responder) and hence are transparent to the intermediate AP(s). In a first case, the SBP Responder is an AP (or AP MLD). In a second case, the SBP Responder is a non-AP STA (or a non-AP MLD). Advantageously, SBP can be achieved even when none of the AP(s) that are in range of the SBP Initiator support SBP. Further, SBP can be achieved even when none of the AP(s) support SBP. For example, the Data frames may be any IEEE 802.11 Data frame (including valid subtypes, e.g., non-QoS Data frame, QoS Data frame etc.), or an IEEE 802.15.4 Data frame etc. The Data frame may carry a single MSDU (medium access control (MAC) service data unit) or may carry an aggregate MSDU (A-MSDU). The data frame may also be called a Data MPDU (medium access control (MAC) protocol data unit)) and may be an independent unit or may be carried in an aggregated-MPDU (A-MPDU).

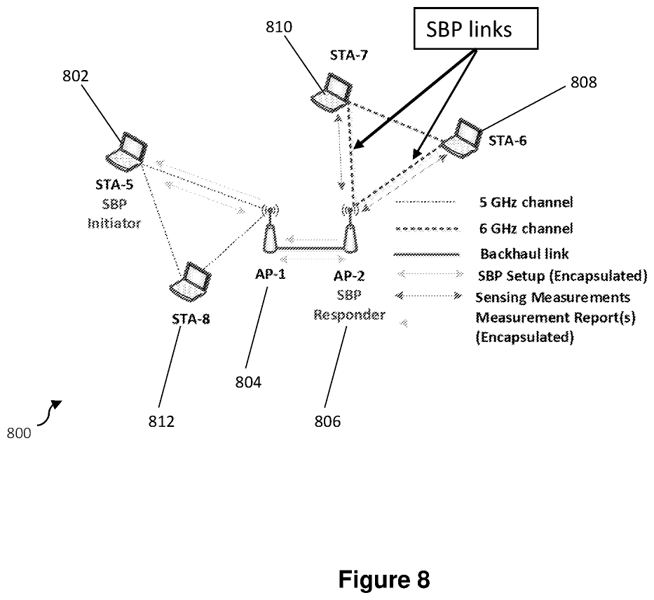

Referring to illustration 800 of FIG. 8, in an embodiment where SBP responder is an AP (or AP MLD), SBP frames may be encapsulated in a Data frame (e.g., in a SBP Ethertype 89-0d Data frame or in a higher layer protocol message such as a 1905.1 (IEEE 1905.1) message etc.), and the SBP Responder may be any AP (e.g., AP-2 806) addressed by an Address 3 (A3) field of the Data frame that encapsulates the SBP Request frame. The encapsulated SBP frames may be forwarded by the intermediate AP(s) (e.g., AP-1 804) following the baseline addressing rules regarding forwarding of Data frames. Since the SBP frames are encapsulated in a Data frame, the intermediate AP (e.g., AP-1 804) need not be SBP capable, or need not even be 11bf capable in order to forward the frame to the SBP Responder AP. In illustration 800, AP-1 804 is not SBP capable, but AP-2 806 is. SBP Initiator (STA-5) 802 requests AP-2 806 to act as the SBP Responder and perform sensing measurements on its behalf. BSS-1 (AP-1 804 and associated non-AP STAs STA-5 802 & STA-8 812) and BSS-2 (AP-2 806 and associated non-AP STAs STA-6 808 & STA-7 810) may be in different locations (e.g., in different rooms/floors etc.). Advantageously, SBP can be achieved even when none of the AP(s) that are in range of the SBP Initiator support SBP.

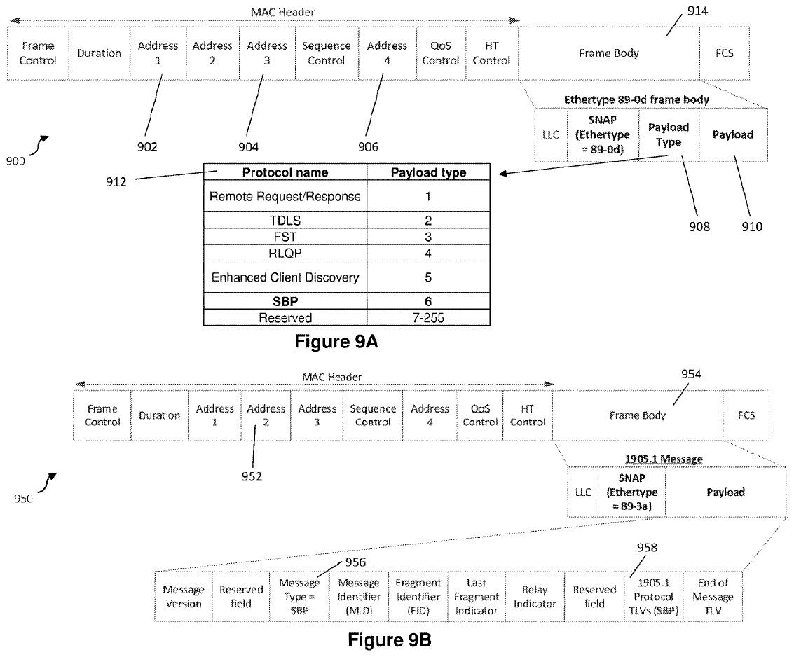

FIG. 9A depicts an illustration of an exemplary SBP Ethertype 89-0d Data frame 900 according to various embodiments of the present disclosure. When encapsulated in a SBP Ethertype 89-0d Data frame such as SBP Ethertype 89-0d Data frame 900, the frame body of a SBP frame and Authorization Validation frame (e.g., content of the frames except the MAC header and the FCS field) may be carried in Payload field 910 within the frame body 914 of the Ethertype 89-0d Data frame 900. Authorization validation frames refer to frames for requesting/carrying a password. Authorization validation frames exchanges may be performed between a sensing responder and a SBP Initiator during a Measurement Setup Request procedure. If the Authorization Validation is successful, the sensing responder accepts the Measurement Setup Request and the SBP Setup is successful. If the Authorization Validation is unsuccessful, the sensing responder rejects the Measurement Setup Request and the SBP Setup fails. Referring back to FIG. 8, the SBP Initiator (STA-5 802) encapsulates the SBP Request frame in a SBP Ethertype 89-0d Data frame; sets the A3 field of the Data frame to the MAC Address of the intended SBP Responder (AP-2 806) and transmits the frame to AP-1 804, which based on the A3 field, forwards the frame to AP-2 806. Similarly, the SBP Responder (AP-2 806) encapsulates the SBP Response frame and SBP Report frames in SBP Ethertype 89-0d Data frames; sets the A3 field of the Data frame to the MAC Address of the intended SBP Initiator (STA-5 802) and transmits the frame to AP-1 804, which based on the A3 field, forwards the frame to STA-5 802.

Address 4 (A4) field 906 is only present when the frames are transmitted by one AP to another AP and carry the Source Address (SA), i.e., the MAC address of the STA from which the frame originated (i.e., the SBP Initiator or the SBP Responder). In an encapsulated SBP Request frame and encapsulated SBP Termination frame transmitted by the SBP Initiator, the Address 3 (A3) field 904 carries the Destination Address (DA) and indicates the AP that is requested to be the SBP Responder. If it is different from the AP receiving the encapsulated SBP Request frame (identified by the Address 1 (A1) field 902 carrying the Receiver Address (RA)), the frame is forwarded to the AP addressed by the A3 field 904. When both the A1 and A3 fields match the MAC Address of an AP, it knows that the SBP Request is addressed to it, and it is the SBP Responder. When the frame is received by an AP from another AP, the A4 field 906 carries the SA (e.g., SBP Initiator's address). Similarly, in the reverse direction (e.g., in an encapsulated SBP Response frame, or an encapsulated SBP Report frame transmitted by the SBP Responder), when an AP is the receiver, the A3 field (DA) 904 carries the SBP Initiator's address and the A4 field (SA) 906 carries the SBP Responder's address. In the frame transmitted by the final AP to the SBP Initiator, the A3 field (SA) 904 carries the SBP Responder's address.

Further, Payload Type field 908 indicates a value corresponding to a payload type based on example table 912. For example, a value of ‘5’ corresponds to an Enhanced Client Discovery payload type, while a value of ‘6’ corresponds to a SBP payload type.

Alternatively, instead of a SBP Ethertype 89-0d Data frame, a new 1905.1 Message Type (SBP) may be used to communicate the SBP related messages, such as 1905.1 Message 950 of FIG. 9B which depicts an example illustration of an 802.11 data frame for encapsulating a 1905.1 SBP message. When transmitted over the air (e.g., between non-AP STA and associated AP), the 1905.1 SBP messages are encapsulated using 802.11 data frames as shown in illustration 950. For example, Address 2 (A2) field 956 is set to SBP (e.g., value=0x8036) and 1905.1 Protocol TLVs (SBP) field 958 is set in accordance with values indicated in Tables 2-5. Details of the 1905.1 Message is described in later sections. When encapsulated in a 1905.1 message, contents of the SBP frame and Authorization Validation frame (e.g., content of the frames except the MAC header and the FCS field) may be carried as TLVs within the payload field of the 1905.1 message, while the 1905.1 message itself is carried within the frame body 954 of the Data frame 950. Referring back to FIG. 8, the SBP Initiator (STA-5 802) encapsulates the SBP Request frame in a Data frame carrying a 1905.1 SBP message; sets the A3 field of the Data frame to the MAC Address of the intended SBP Responder (AP-2 806) and transmits the frame to AP-1 804, which based on the A3 field, forwards the frame to AP-2 806. Similarly, the SBP Responder (AP-2 806) encapsulates the SBP Response frame and SBP Report frames in a Data frame carrying a 1905.1 SBP message; sets the A3 field of the Data frame to the MAC Address of the intended SBP Initiator (STA-5 802) and transmits the frame to AP-1 804, which based on the A3 field, forwards the frame to STA-5 802.es, such as 1905.1 Message 950 of FIG. 9B which depicts an example illustration of an 802.11 data frame for encapsulating a 1905.1 SBP message. When transmitted over the air (e.g., between non-AP STA and associated AP), the 1905.1 SBP messages are encapsulated using 802.11 data frames as shown in illustration 950. For example, Address 2 (A2) field 956 is set to SBP (e.g., value=0x8036) and 1905.1 Protocol TLVs (SBP) field 958 is set in accordance with values indicated in Tables 2-5. Details of the 1905.1 Message is described in later sections. When encapsulated in a 1905.1 message, contents of the SBP frame and Authorization Validation frame (e.g., content of the frames except the MAC header and the FCS field) may be carried as TLVs within the payload field of the 1905.1 message, while the 1905.1 message itself is carried within the frame body 954 of the Data frame 950. Referring back to FIG. 8, the SBP Initiator (STA-5 802) encapsulates the SBP Request frame in a Data frame carrying a 1905.1 SBP message; sets the A3 field of the Data frame to the MAC Address of the intended SBP Responder (AP-2 806) and transmits the frame to AP-1 804, which based on the A3 field, forwards the frame to AP-2 806. Similarly, the SBP Responder (AP-2 806) encapsulates the SBP Response frame and SBP Report frames in a Data frame carrying a 1905.1 SBP message; sets the A3 field of the Data frame to the MAC Address of the intended SBP Initiator (STA-5 802) and transmits the frame to AP-1 804, which based on the A3 field, forwards the frame to STA-5 802.

Upon receiving SBP frames encapsulated in a SBP Ethertype 89-0d Data frames or a 1905.1 message, the SBP Initiator and SBP Responder will process them exactly as if the original SBP frames (which are management frames) were received.

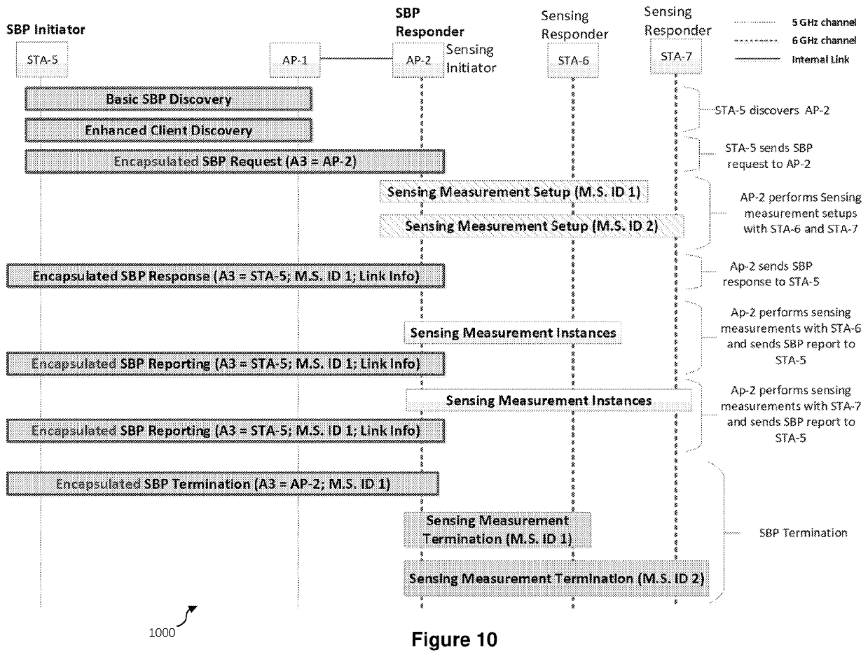

FIG. 10 shows an exemplary flowchart 1000 illustrating an overview of a SBP procedure between the APs and non-AP STAs, for example, the APs and non-AP STAs as shown in illustration 800 of FIG. 8. In a discovery phase, STA-5 802 (e.g., the SBP Initiator) discovers AP-2 806 (e.g., the SBP Responder) through Basic SBP Discovery and optionally AP-2 associated non-AP STAs through Enhanced Client Discovery. In Basic SBP Discovery, the SBP Initiator discovers the SBP capabilities of the SBP Responder (AP-2) e.g., through Reduced Neighbor Report element in Beacon/Probe Response frames. In Enhanced Client Discovery, an AP (e.g., AP-2 806) typically already has basic information about associated STAs (e.g., STA-6 808 and STA-7 810) e.g., operating channel(s), sensing capabilities, R2R sensing capabilities etc. The SBP Initiator can obtain such information from the AP using Level 1 Client Discovery Query. Upon receiving request from an SBP Initiator (or even on its own), an AP may also collect other relevant information from its associated STAs, e.g., location/position of the STAs, Received Signal Strength Indicator (RSSI) or propagation loss to/from the STAs (e.g., as a representative indication of distance between STAs and the AP), information about the STA's neighboring STAs including link metrics, and other similar information. The SBP Initiator can obtain such information about an AP's associated STAs (and their neighbor STAs) from the AP using Level 2 Client Discovery Query. Based on the above information, the SBP Initiator can select one or more APs as SBP Responder(s) as well as one or more non-AP STAs as sensing responders for the SBP Procedure. Alternatively, e.g., if the AP does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure. Alternatively, it is also possible that the SBP Initiator initially requests for measurement results from “all/many” available links but subsequently selects a subset of links that are most suitable for the sensing application in a subsequent SBP request. The link selection may be based on statistical analysis of the sensing measurement reports for the links; for example, the links in which channel state information (CSI) feedback are insensitive to the needs of the sensing application may be omitted in later SBP requests.

In a SBP setup phase, SBP Initiator STA-5 802 sets the A3 (DA) field of an encapsulated SBP Request frame (e.g., in an Ethertype 89-0d Data frame) as the MAC address of AP-2 806 and sends the encapsulated SBP request to AP-2 806 (via AP-1 804) to request it to perform measurements on its one or more links, for example the links attached to STA-6 808 and STA-7 810. The AP-2 806 performs sensing measurement setups with STA-6 808 and STA-7 810, and then sends an encapsulated SBP Response to STA-5 802 via AP-1 804. The encapsulated SBP Response transmitted by AP-2 806 indicates STA-5 802 in the A3 field. In a sensing measurement phase, AP-2 806 performs sensing measurements with STA-6 808 and sends an encapsulated SBP Report to STA-5 802 via AP-1 804, as well as performs sensing measurements with STA-7 810 and sends an encapsulated SBP Report to STA-5 802 via AP-1 804. When transmitting to AP-1 804, the SBP Responder (e.g., AP-2 806) sets the A3 (DA) field of the encapsulated SBP Response frame and encapsulated SBP Report frames to the MAC Address of STA-5 802. In a termination phase, SBP Initiator STA-5 802 sets the A3 (DA) field of an encapsulated SBP Termination Request as the MAC address of AP-2 806 and sent to it via AP-1 804. The AP-2 806 then sends a sensing measurement termination instruction to STA-6 808 and STA-7 810.

In the flowchart 1000, AP-1 804 may perform the forwarding of the SBP frames between STA-5 and AP-2. The A3 field value (indicating STA-5) in the encapsulated SBP Response frame and the encapsulated SBP Report frame shown in the flowchart 1000 may only be applicable when the receiver is AP-1 804. When transmitted by AP-1 804 to its associated STAs (e.g., to STA-5 802), the A3 field carries the address of the SBP Responder (e.g., AP-2 806).

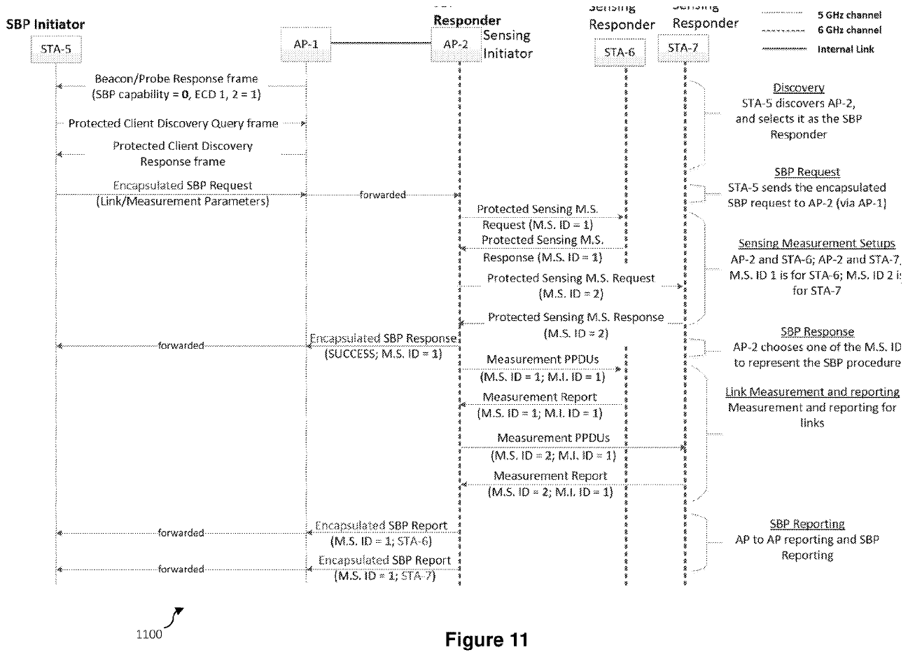

FIG. 11 shows an exemplary flowchart 1100 illustrating a signaling overview of flowchart 1000 illustrated in FIG. 10. In the discovery phase, STA-5 802 discovers AP-2 806 (e.g., through Beacon/Probe Response frames) and selects it as the SBP Responder. In the SBP setup phase, STA-5 802 sets the A3 (DA) field of an encapsulated SBP Request as AP-2 806, transmits the request to AP-1 804 which then forwards it to AP-2 806. Sensing measurement setups are then performed between AP-2 806 and STA-6 808 (e.g. Protected Sensing Measurement Setup (M.S.) Request with M.S. ID=1 is sent from AP-2 806 to STA-6 808, and STA-6 808 responds by sending a Protected Sensing M.S. Response with M.S. ID=1), as well as between AP-2 806 and STA-7 810 (e.g. Protected Sensing M.S. Request with M.S. ID=2 is sent from AP-2 806 to STA-7 810, and STA-7 810 responds by sending a Protected Sensing M.S. Response with M.S. ID=2), wherein M.S. ID=1 is for STA-6 808 and M.S. ID=2 is for STA-7 810. AP-2 806 then chooses one of the M.S. ID (e.g., 1) to represent the SBP procedure. For example, AP-2 806 sets the A3 (DA) field of an encapsulated SBP frame as STA-5 802, chooses M.S. ID=1 to represent the SBP procedure, and sends the encapsulated SBP Response frame to AP-1 804 which forwards it to STA-5 802.

In the sensing measurement phase, link measurement and reporting are performed by the AP-2 806 by initiating appropriate measurement instances (e.g., TB measurement instances indicating the appropriate M.S. ID) and transmitting Sensing NDPA frame and measurement PPDUs (e.g., I2R NDP) to STA-6 808 and STA-7 810 and receiving measurement reports (indicating the appropriate M.S. ID) from STA-6 808 and STA-7 810 respectively in response to the measurement PPDUs. Alternatively, it is also possible that AP-2 806 solicits measurement PPDUs (e.g., R2I NDPs) from STA-6 808 and STA-7 810 by transmitting Sensing Sounding Trigger frames and AP-2 calculates the sensing measurements based on the R2I NDPs. In a reporting phase, AP to AP reporting and SBP reporting are performed. For example, an encapsulated SBP Report based on measurement report or measurement PPDUs from STA-6 808 may be sent from the AP-2 806 (e.g., indicating M.S. ID=1) to AP-1 804 which then forwards it to STA-5 802. An encapsulated SBP Report based on measurement report or measurement PPDUs from STA-6 810 may also be sent from the AP-2 806 (e.g., indicating M.S. ID=2) to AP-1 804 which then forwards it to STA-5 802. Before sending the encapsulated SBP Report, the SBP Responder AP-2 806 may perform conversion of the M.S. IDs (if needed) and add link information to the measurement report(s).

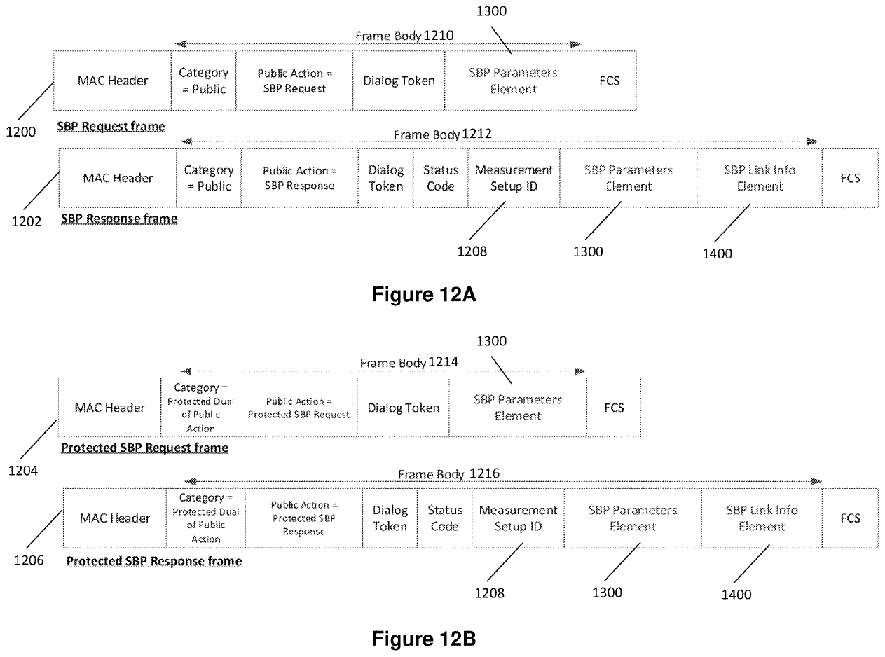

FIG. 12A shows exemplary structures of SBP Request frame 1200 and SBP Response frame 1202 according to various embodiments of the present disclosure. FIG. 12B shows exemplary structures of Protected SBP Request frame 1204 and Protected SBP Response frame 1206 according to various embodiments of the present disclosure. During SBP setup, an SBP Initiator and an SBP Responder may exchange SBP Request/Response frames to setup SBP procedure if security association (SA) does not exist between them. If SA exists, Protected SBP Request/Response frames are used. Measurement Setup ID field 1208 (e.g., in the SBP Response frames 1202 and 1206) is set to the Measurement Setup ID value chosen to represent the SBP procedure by the AP that accepts the corresponding SBP request. The Measurement Setup ID field 1208 is present in a SBP Response frame only if the status code is equal to SUCCESS. A SBP Request frame, a SBP Response frame, a Protected SBP Request frame or a Protected SBP Response frame may be encapsulated in a SBP Ethertype89-0d Data frame by including the Frame body 1210, 1212, 1214 or 1216 in the payload field of a SBP Ethertype89-0d frame body. Similarly, a SBP Request frame, a SBP Response frame, a Protected SBP Request frame or a Protected SBP Response frame may be encapsulated in a 1905.1 message by including the Frame body 1210, 1212, 1214 or 1216 in the corresponding SBP TLV.

Although not shown in the FIGS. 12A and 12B, a timeout or a non-response period may also be included in the SBP Request frames 1200 and/or Protected SBP Request frame 1204 to indicate a time duration. If the SBP initiator does not receive a SBP Response during the time duration, the SBP procedure initiation will be terminated and all resources allocated for the SBP procedure (e.g., memory) will be released. Similarly, a timeout or a non-response period may also be included in the SBP Response frame 1202 and/or Protected SBP Response frame 1206 to indicate a time duration. If the SBP Responder does not get any response from the SBP Initiator during the time duration, the SBP procedure will be terminated and all resources allocated for the SBP procedure (e.g., memory, SBP Measurement Setup ID, etc.) will be released.

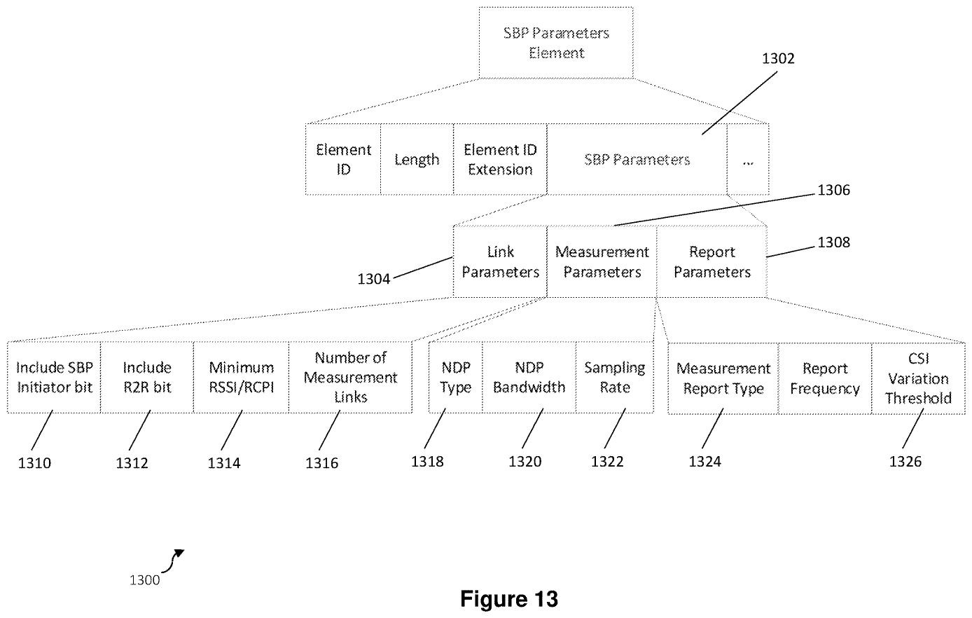

The SBP Initiator and SBP Responder may indicate the operation attributes to be used for the WLAN Sensing procedure in a SBP Parameters element 1300 present in the SBP Request frames 1200 and 1204 as well as SBP Response frames 1202 and 1206. The SBP Parameters element 1300 is shown in more detail in FIG. 13. There may be a SBP Parameters field 1302 in the SBP Parameters element 1300, comprising a Link Parameters field 1304, a Measurement Parameters field 1306 and a Report Parameters field 1308. The Link Parameters field 1304 indicates attributes related to the links to be measured, and comprises an Include SBP Initiator bit subfield 1310, an Include R2R bit subfield 1312, a Minimum RSSI/RCPI subfield 1314 and a Number of Measurement Link subfield 1316. The Include SBP Initiator bit subfield 1310 is set to 1 to request to include the SBP Initiator as one of the sensing responders. The Include R2R bit subfield 1312 is set to 1 to indicate that sensing responder to sensing responder (R2R) links may also be considered. The Minimum RSSI/RCPI subfield 1314 indicates the average receive signal strength indicator (RSSI) or received channel power indicator (RCPI) observed for the frames transmitted on a selected link that is expected to be above an indicated level. The Number of Measurement Links subfield 1308 indicates the number of links to be used for the sensing measurements.

The Measurement Parameters field 1306 indicates attributes related to the measurement PPDUs, and comprises a NDP Type subfield 1318 that indicates the Null Data Packet (NDP) type (or format, e.g., High Efficiency (HE), or Extremely High Throughput (EHT) or Ranging etc.) to be used to measure the channels, a NDP Bandwidth subfield 1320 that indicates the channel bandwidth of the NDP to be used to measure the channels, and a Sampling Rate subfield 1322 for indicating the frequency of measurements, for example how often the sensing measurements are performed e.g., in Hz (number of measurements per second). Further, the Report Parameters field 1308 indicates attributes related to the SBP reporting, and comprises at least a Measurement Report Type subfield 1324 that identifies the type of sensing measurement report to be used during the SBP Reporting, and a CSI Variation Threshold subfield 1326 that shows a number between 0 to 1 that indicates the Threshold value to be used to determine whether the change in measured CSI is significant enough for the AP to generate the SBP Report

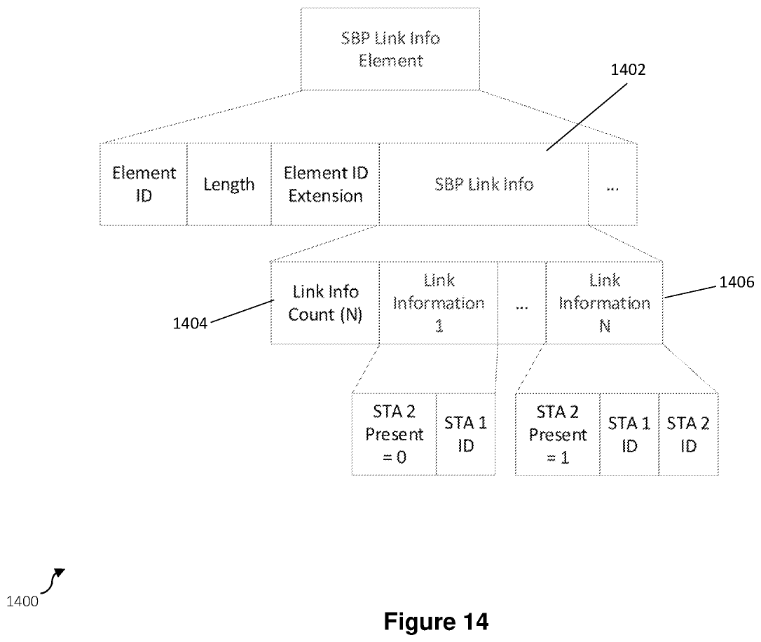

The SBP Responder may indicate the information of the measurement links corresponding to the SBP procedure in a SBP Link Info element 1400 that is present in the SBP Response frames 1202 and 1206, and shown in more detail in FIG. 14. There may be a SBP Link Info field 1402 in the SBP Link Info element 1400, comprising a Link Info Count field 1404 that indicates the number of Link Information fields present in the SBP Link Info field 1402 (e.g., in this case, the indicated number is N) and 1 to N Link Information fields 1406. Each of the 1 to N Link Information fields 1406 may carry IDs (e.g., MAC Address or AIDs) of the STAs or APs, to identify the link corresponding to the sensing measurement report. STA 1 ID is always present, while STA 2 ID is only present for R2R links or for other BSS's links. Alternatively, instead of STA IDs, the SBP Responder may assign unique Link ID to identify each measurement link. For example, the first Link Information field (e.g., Link Information 1 field) may comprise a STA 1 ID subfield that identifies the non-AP STA for the AP's own basic service set (BSS) for the Initiator to Responder (I2R) or Responder to Initiator (R2I) links. The last Link Information field (e.g., Link Information N field) may comprise STA 1 ID and STA 2 ID subfields that identify the two non-AP STAs of the AP's own BSS for R2R links. If the link is from another AP's BSS, STA1 ID and STA2 ID may identify the STAs corresponding to the link from the other BSS.

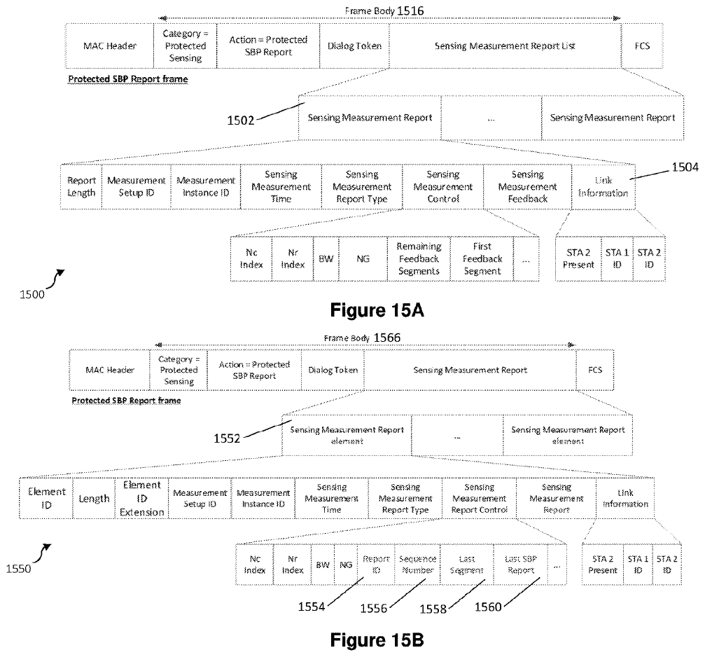

During the SBP reporting phase, Sensing Measurement results obtained in a WLAN sensing procedure resultant from an SBP request is reported to the SBP initiator (by the SBP Responder) in a Protected SBP Report frame (e.g., Protected SBP Report frame 1500 of FIG. 15A) which is either constructed by the AP itself (if the AP is also the sensing receiver), or, constructed by adding a Link Information field (e.g., Link Information field 1504) to each Sensing Measurement Report field (e.g., Sensing Measurement Report field 1502) obtained in the Sensing Measurement Report frame sent by the Sensing Responders in its own BSS as well as those received from other APs. If the measurement setup (M.S.) IDs assigned by the other AP(s) is different from the M.S. ID assigned by the SBP Responder for the SBP procedure, the SBP Responder also replaces the M.S. ID(s) of the applicable Sensing Measurement Reports to the M.S. ID that represents the SBP procedure.

The Link Information field 1504 carries IDs (e.g., MAC Address or AIDs) of the sensing responders to identify the link corresponding to the sensing measurement report. STA 1 ID is always present, while STA 2 ID is only present for R2R links or for other BSS's links. Alternatively, the Link Information field 1504 may carry a unique Link ID that identifies each corresponding measurement link. The Sensing Measurement Report field 1502 may further comprise at least a Report Length field that indicates the length of the Sensing Measurement Report field 1502, a Measurement Setup ID field that identifies the Measurement Setup ID value chosen to represent the SBP procedure by the AP that accepts the corresponding SBP request, a Sensing Measurement Time field that indicates a Measurement timestamp e.g., the time at which the measurement was performed by the Sensing Receiver, and a Sensing Measurement Feedback field that indicates sensing measurement results (e.g., CSI, Partial_CSI, of other similar measurement results).

Alternatively, it is also possible that instead of using fields, the Sensing Measurement reports are carried in one or more Sensing Measurement Report elements (each with its own element ID, length and Element ID Extension fields) and already carries the Link Information field (e.g., as shown in 1552 of the Protected SBP Report frame 1550 of FIG. 15B). Since an extended element can carry maximum of 254 octets, a single element may not be enough to carry the whole sensing measurement report and may be segmented into two or more reports and carried in two or more elements. The Report ID subfield 1554 uniquely identifies a sensing measurement report that may be segmented into multiple Sensing Measurement Report elements and is the same across the multiple segments of the same sensing measurement report. The Sequence Number subfield 1556 carries the sequence number of the sensing measurement report segment carried in the Sensing Measurement Report element. The Last Segment subfield 1558 is set to 1 in the last Sensing Measurement Report element sent that has the same Report ID. Otherwise, it is set to 0. The Last SBP Report subfield 1560 is set to 1 in the last Sensing Measurement Report element sent in the SBP reporting phase of the current sensing measurement instance. Otherwise, it is set to 0.

A SBP Report frame is encapsulated in a SBP Ethertype89-0d Data frame by including the Frame body 1516, 1566, comprising a Category field (e.g., set to “Protected Sensing”), an Action Field (e.g., set to “Protected SBP Report”), a Dialog Token field and Sensing Measurement Report list field (e.g., comprising the Sensing Measurement Report fields), in the payload field of a SBP Ethertype89-0d frame body. Similarly, a SBP Report frame is encapsulated in a 1905.1 message by including the Frame body 1516, 1566 in the corresponding SBP TLV. It is also possible that instead of defining new frame type (Protected SBP Report frame), the Protected Sensing Measurement Report frame is reused for the SBP reporting, i.e., the Protected Sensing Measurement Report frame is also used for reporting the sensing measurement reports to the SBP Initiator.

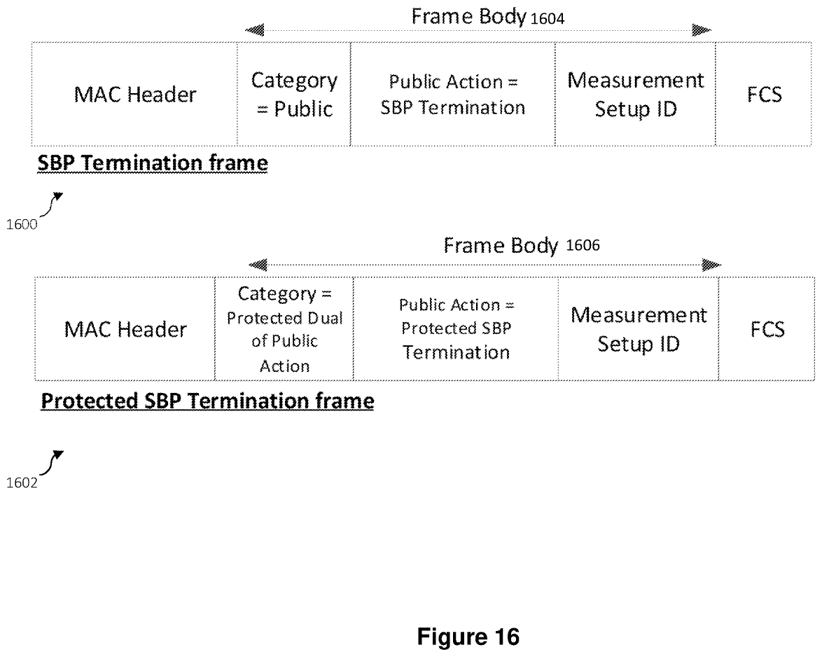

The SBP procedure may be terminated at any time by either the SBP initiator or the SBP responder by transmitting an SBP Termination frame or a Protected SBP Termination frame e.g., SBP Termination frame 1600 and Protected SBP Termination frame 1602 of FIG. 16. The SBP Termination frame 1600 comprises a MAC Header (e.g., comprising a Frame Control field, Duration field, RA field and TA field), a Category field which is set to “Public”, a Public Action field which is set to “SBP Termination”, a Measurement Setup ID field and a FCS field. The Protected SBP Termination frame 1602 comprises a MAC Header (e.g., comprising a Frame Control field, Duration field, RA field and TA field), a Category field which is set to “Protected Dual of Public Action”, a Public Action field which is set to “Protected SBP Termination”, a Measurement Setup ID field and an FCS field. The Measurement Setup ID field is set to the Measurement Setup ID value assigned by the SBP responder (AP) corresponding to the SBP procedure to be terminated. For both termination frames, the frame body 1604 or 1606 comprising the Category field, Public Action field and Measurement Setup ID field may be carried in the payload field of encapsulated SBP Ethertype 89-0d frames or in the corresponding SBP TLV within a 1905.1 message.

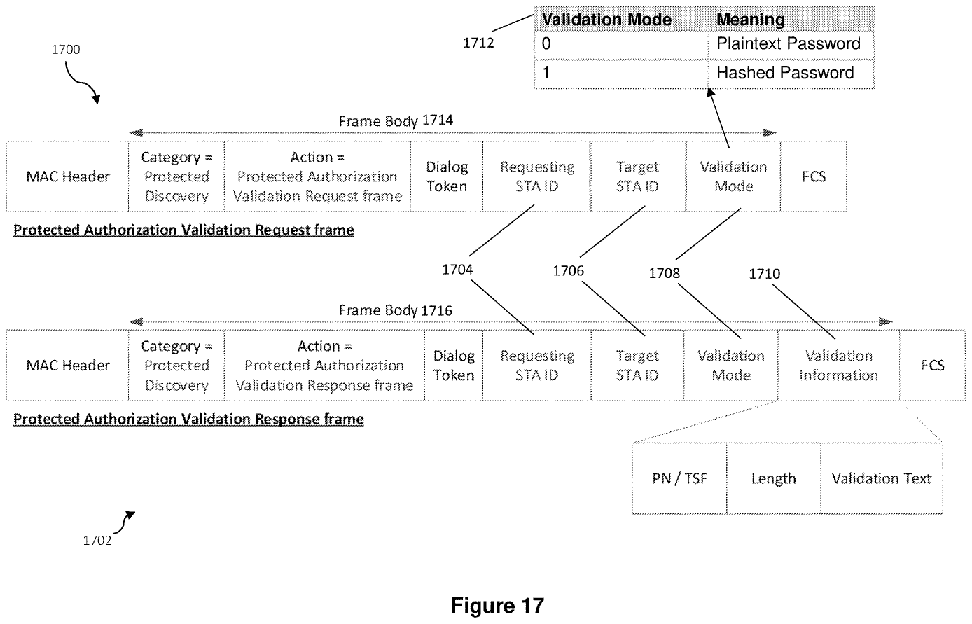

During SBP Setup, authorization validation may be performed, in which the AP uses the “Requesting STA ID” and the “Target STA ID” fields to forward the Authorization Validation Request/Response frames e.g., Protected Authorization Validation Request frame 1700 and Protected Authorization Validation Response frame 1702 of FIG. 17. The Protected Authorization Validation Request frame 1700 comprises a MAC Header, a FCS field, and a frame body comprising a Category field which is set to “Protected Discovery”, an Action field which is set to “Protected Authorization Validation Request frame”, a Dialog Token field, a Requesting STA ID field 1704, a Target STA ID field 1706 and a Validation Mode field 1708. The Protected Authorization Validation Response frame 1702 comprises a MAC Header, an FCS field, and a frame body comprising a Category field which is set to “Protected Discovery”, an Action field which is set to “Protected Authorization Validation Response frame”, a Dialog Token field, a Requesting STA ID field 1704, a Target STA ID field 1706, a Validation Mode field 1708 and a Validation Information Field 1710.

For both frames, the Requesting STA ID field 1704 indicates the ID (e.g., MAC Address) of the STA requesting authorization validation, the Target STA ID field 1706 indicates the SBP Initiator STA's ID (e.g., MAC Address), and the Validation Mode field 1708 indicates a value corresponding to a validation mode as shown in example table 1712. For example, a value of ‘0’ indicates a plaintext password, while a value of ‘1’ indicates a hashed password. Further, the Validation Information field 1710 may comprise a PN/TSF field, a length field, and a Validation Text field which carries the plaintext password or hashed password based on the Validation Mode field 1708. Further, the frame body 1714 of the Protected Authorization Validation Request frame 1700 and or the frame body 1716 Protected Authorization Validation Response frame 1702 may be carried in the payload field of encapsulated SBP Ethertype 89-0d frames or in corresponding SBP TLV within a 1905.1 message.

Upon reception of a Sensing Measurement Setup Request for a SBP procedure, the STA receiving the request may perform over the air Authorization Validation to verify that the SBP Initiator is authorized for the SBP procedure by transmitting a Protected Authorization Validation Request frame to the SBP Initiator (via the AP). Upon reception of the Protected Authorization Validation Request frame, a SBP Initiator transmits the Protected Authorization Validation Response frame carrying the Validation information (e.g., a shared password) in the format requested.

Authorization Validation Request/Response may be skipped if the STA has other means to verify the SBP Initiator's authorization. For example, the STA may maintain a list of authorized devices, or it may consult with a list of authorized devices from a database on a server, or other similar methods. A hashed password may be used, for example SHA-256(Key, PN/TSF∥“Plain text password”), where Key is a common private secret key known to both parties, e.g., a Pairwise Transient Key (PTK) generated during the Security Association, or a dedicated secret key to be used for sensing provided by the AP/upper layer application. PN/TSF is the value of the PN/TSF field, and the transmitter of the hashed password may be configured to ensure that the same value is never used twice to prevent replay attacks. For example, it may be a monotonously increasing number, or may contain the current value of the transmitters Time Synchronization Function (TSF).

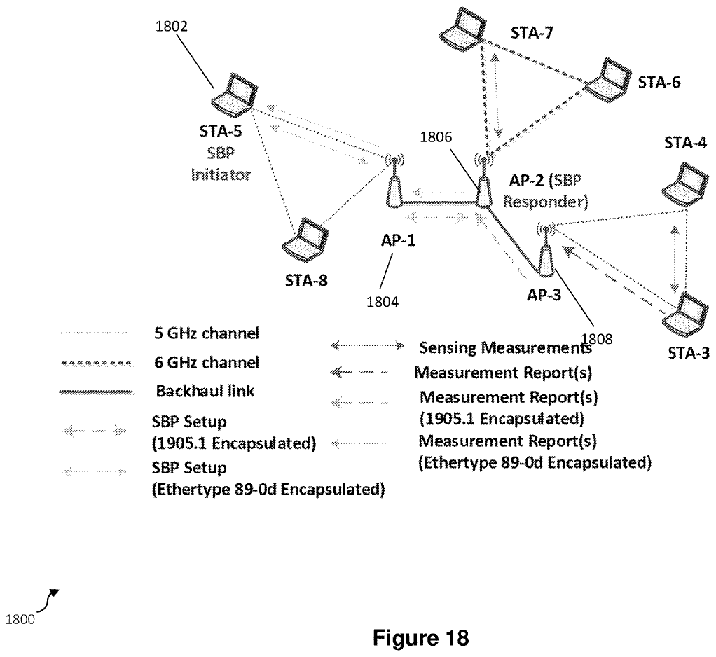

In an embodiment, the SBP Responder (AP) may request other AP(s) to also act as Sensing Initiators and perform WLAN Sensing for the SBP procedure. The other AP(s) may be co-located AP(s), or other AP(s) affiliated with the same MLD, or other AP(s) connected over wired/wireless backhaul (e.g., AP(s) that are part of the same enterprise network, EasyMesh network, or other similar networks). The SBP Responder collects the sensing measurement reports from the other APs and sends to the SBP Initiator after encapsulating as data frames. 1905.1 (IEEE 1905.1) messages are used to encapsulate the SBP frames between SBP Responder and other Aps. Referring to illustration 1800 of FIG. 18, AP-1 1804 is not SBP capable while AP-2 1806 and AP-3 1808 are SBP capable. AP-1 1804 need not even be 11bf capable. SBP Initiator (STA-5 1802) requests AP-2 1806 to act as the SBP Responder and perform sensing measurements on its behalf. AP-2 1806 (e.g., the SBP Responder) requests AP-3 1808 to act as an additional Sensing Initiator for the SBP procedure. BSS-1 (e.g., network comprising AP-1 1804 and associated non-AP STAs STA-5 1802 & STA-8), BSS-2 (e.g., network comprising AP-2 1806 and associated non-AP STAs STA-6 & STA-7) and BSS-3 (e.g., network comprising AP-3 1808 and associated STAs STA-3 and STA-4) may be in different locations (e.g., in different rooms/floors etc.), such as a mesh network.

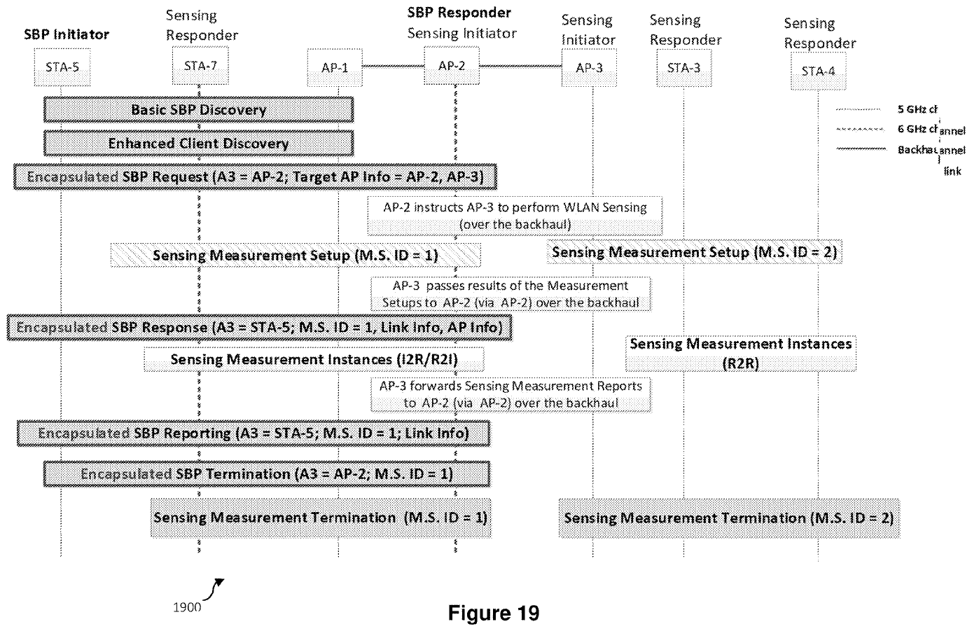

FIG. 19 shows an exemplary flowchart 1900 illustrating an overview of the SBP procedure of illustration 1800. As mentioned above, the AP-3 1808 acts as an additional Sensing initiator. After Basic SBP Discovery and Enhanced Client Discovery are performed, the SBP Initiator STA-5 1802 sets the A3 (DA) field of the Encapsulated SBP Request as the MAC address of AP-2 1806 (in A3), specifies AP-2 1806 and AP-3 1808 as Target APs, and transmits the Encapsulated SBP Request to AP-1 1804 which forwards it to the AP-2 1806. The AP-2 1806 receives the Encapsulated SBP Request and accordingly instructs AP-3 1808 to perform WLAN Sensing (e.g., over the backhaul). Higher layer protocols may be used for communications (e.g., using 1905 (IEEE 1905) messages) between the APs, such as for this instruction to AP-3 1808 to perform WLAN Sensing.

Sensing Measurement Setup is then performed between Sensing Responder STA-7 and SBP Responder/Sensing Initiator AP-2 1806 (e.g., with M.S. ID=1), as well as performed between additional Sensing Initiator AP-3 1808, Sensing Responder STA-3 and Sensing Responder STA-4. Thereafter, AP-3 1808 passes the results of the Sensing Measurement Setups to AP-2 1806 over the backhaul, and AP-2 1806 then transmits encapsulated SBP Response frames to STA-5 1802 via AP-1 1804 (e.g., encapsulated SBP Response frame with A3 field set to STA-5 1802, M.S. ID=1, link information and AP information). Sensing Measurement Instances (e.g., I2R, R2I and R2R) may then be performed, and the AP-3 1808 forwards Sensing Measurement Reports based on the R2R Sensing Measurement Instances (e.g., performed by STA-3 and STA-4) to AP-2 1806 over the backhaul. AP-2 1806 then transmits encapsulated SBP Report frames (e.g., with A3 field set to STA-5 1802, M.S. ID=1, and link information for the sensing reports) reporting these Sensing Measurement Instances (e.g., I2R, R2I and R2R) to STA-5 1802 via AP-1 1804. When transmitting encapsulated SBP Response frames or encapsulated SBP Report frames to AP-1 1804, the SBP Responder (AP-2 1806) sets the A3 (DA) field of the encapsulated SBP Response frames and encapsulated SBP Report frames to STA-5 1802.

To terminate the SBP procedure, an encapsulated SBP Termination frame (e.g., with A3 field set to AP-2 1806, and M.S. ID=1) may be transmitted from STA-5 1802 to AP-1 1804 which forwards it to AP-2 1806. AP-2 1806 accordingly sends Sensing Measurement Termination instructions (e.g., with M.S. ID=1) to STA-7, and AP-3 1808 accordingly sends Sensing Measurement Termination instructions (e.g., with M.S. ID=2) to STA-3 and STA-4. It will be appreciated that the A3 field value (e.g., indicating STA-5 1802) in the encapsulated SBP Response frame and the encapsulated SBP Report frame shown in the flowchart 1900 is only applicable when the receiver is AP-1 1804. When transmitted by AP-1 1804 (to STA-5 1802), the A3 field (SA) carries the address of the SBP Responder (AP-2 1806).

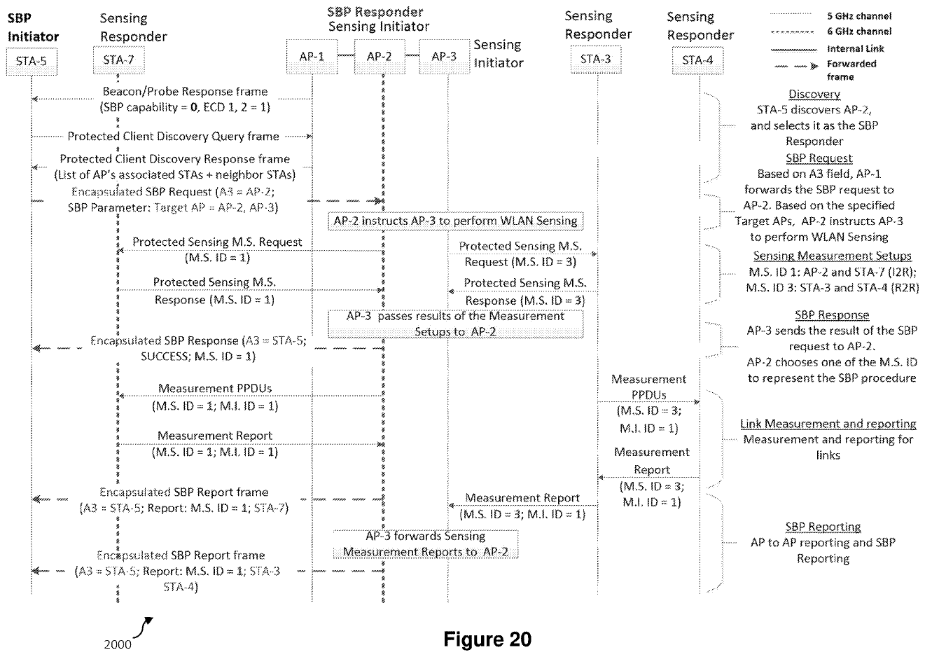

FIG. 20 shows an exemplary flowchart illustrating a signaling overview of the SBP procedure of flowchart 1900. In the discovery phase, STA-5 1802 discovers AP-2 1806 (e.g., through Beacon/Probe Response frames) and selects it as the SBP Responder. STA-5 1802 may transmit a Protected Client Discovery Query frame to AP-1 1804, and the AP-1 1804 may respond by transmitting a Protected Client Discovery Response frame (e.g., comprising a list of the AP's associated STAs and neighboring STAs) to STA-5 1802.

In the SBP setup phase, STA-5 1802 sets the A3 (DA) field of an encapsulated SBP Request as AP-2 1806, specifies AP-2 1806 and AP-3 1808 as Target APs (e.g., in the SBP Parameters field), and transmits the Encapsulated SBP Request to AP-1 1804 which forwards it to the AP-2 1806. AP-2 1806 then instructs AP-3 1808 (e.g., the additional Sensing Initiator) to perform WLAN Sensing. Sensing Measurement Setup (e.g., I2R) is then performed between Sensing Responder STA-7 and SBP Responder/Sensing Initiator AP-2 1806. For example, AP-2 1806 transmits a Protected Sensing M.S. Request with M.S. ID=1 to STA-7, which then responds by transmitting a Protected Sensing M.S. Response with M.S. ID=1 to AP-2 1806. Sensing Measurement Setup (e.g., R2R) is also performed between additional Sensing Initiator AP-3 1808, Sensing Responder STA-3 and Sensing Responder STA-4. For example, AP-3 1808 transmits a Protected Sensing M.S. Request with M.S. ID=3 to STA-3, to request measurement setup for the link between AP-3 and STA-3 as well as the R2R link between STA-3 and STA-4, which then responds by transmitting a Protected Sensing M.S. Response with M.S. ID=3 to AP-3 1808. Thereafter, AP-3 1808 passes the results of the Sensing Measurement Setups to AP-2 1806 over the backhaul. AP-2 1806 chooses one of the M.S. ID to represent the SBP procedure, and transmits an encapsulated SBP Response frame to STA-5 1802 via AP-1 1804 (e.g., encapsulated SBP Response frame with A3 field set to STA-5 1802, status code=SUCCESS, M.S. ID=1, link information and AP information). Sensing Measurement Instances (e.g., I2R, R2I and R2R) may then be performed, for example by the AP-2 1806 sending measurement PPDUs (e.g., indicating M.S. ID=1 and M.I. ID=1) to STA-7 and receiving a measurement report (e.g., indicating M.S. ID=1 and M.I. ID=1) from STA-7 in response to the measurement PPDUs, and by STA-3 sending measurement PPDUs (e.g., indicating M.S. ID=3 and M.I. ID=1) to STA-4 and receiving a measurement report (e.g., indicating M.S. ID=3 and M.I. ID=1) from STA-4 in response to the measurement PPDUs. STA-3 sends the measurement report (e.g., indicating M.S. ID=3 and M.I. ID=1) to AP-3 1808, which then forwards Sensing Measurement Reports based on the R2R Sensing Measurement Instances (e.g., performed by STA-3 based on NDP transmitted by STA-4, and reported in the measurement report sent from STA-3) to AP-2 1806 over the backhaul. AP-2 1806 then transmits the encapsulated SBP Report frames (e.g., an encapsulated SBP Report frame with A3 field set to STA-5 1802, M.S. ID=1, indicating STA-7 for the sensing reports from STA-7, and another encapsulated SBP Report frame with A3 field set to STA-5 1802, M.S. ID=1, indicating STA-3 and STA-4 for the sensing reports from STA-3) to STA-5 1802 via AP-1 1804. When transmitting encapsulated SBP Response frames or encapsulated SBP Report frames to AP-1 1804, the SBP Responder (AP-2 1806) sets the A3 (DA) field of the encapsulated SBP Response frames and encapsulated SBP Report frames to STA-5 1802. Further, the SBP Responder AP-2 1806 may perform conversion of M.S. IDs (if needed) and add link information to the measurement report(s) before transmitting the encapsulated SBP Report frames.

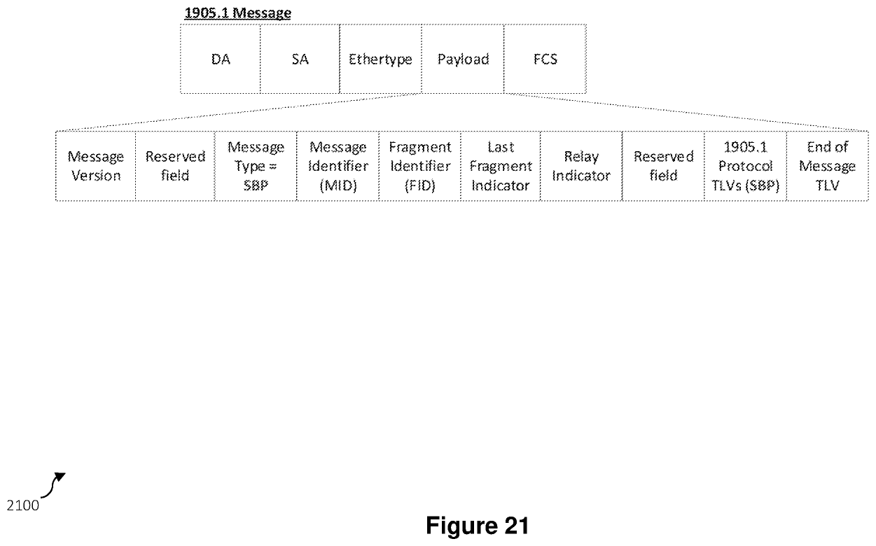

Between the SBP capable APs (e.g., AP-2 1806 and AP-3 1808), a new 1905.1 Message Type (SBP) may be used to communicate the SBP related messages, such as 1905.1 Message 2100 of FIG. 21. The 1905.1 Message 2100 comprises a Destination Address (DA) field, a Source Address (SA) field, an Ethertype field, a Payload field and an FCS field. The Payload field comprises a Message Version field, a Message Type field (e.g., set to a value of 0x8036 to indicate SBP message type), a Message Identifier (MID) field, a Fragment Identifier (FID) field, a Last Fragment Indicator field, a Last Fragment Indicator field, a Relay Indicator field, a 1905.1 Protocol TLVs (Type, Length, Value) field and an End Of Message TLV field. New 1905.1 TLVs may be defined for the 1905.1 Protocol TLVs field to carry the contents of the respective SBP messages, such as shown in Table 1 below.

TABLE 1

| TLV Name | Value | Description |
|---|---|---|
| SBP Request | 0xE0 | Carries the contents |
| | | of an SBP Request frame |
| SBP Response | 0xE1 | Carries the contents |
| | | of an SBP Response frame |
| SBP Report | 0xE2 | Carries the contents |
| | | of an SBP Report frame |
| SBP Termination | 0xE3 | Carries the contents |
| | | of an SBP Termination frame |

A single 1905.1 message type may be defined for all SBP messages, wherein the individual SBP frame types are differentiated by the TLV types. In the forward direction (e.g., from SBP Initiator to SBP Responder), upon receiving an encapsulated SBP frame, the SBP Responder (AP-2) translates the SBP frame (e.g., SBP Request or SBP Termination) to the corresponding 1905.1 message and forwards it to the next AP (AP-3). Similarly in the reverse direction (e.g., from SBP Responder to SBP Initiator), upon receiving a 1905.1 message carrying an SBP message (e.g., SBP Response or SBP Report), the SBP Responder (AP-2) translates the 1905.1 message to the corresponding encapsulated SBP frame and forwards it to the SBP Initiator.

Table 2 below shows the contents of a SBP Request frame for a SBP Request TLV format.

TABLE 2

| Field / Name | Length | Value | Description |
|---|---|---|---|
| tlvType | 1 octet | 0xE0 | SBP Request TLV. |
| tlvLength | 2 octets | 1 | Number of Octets in ensuing field. |
| tlvValue | | | |
| SBP Initiator | 6 octets | variable | MAC Address of the SBP Initiator |
| MAC Address | | | |
| SBP Responder | 6 octets | variable | MAC Address of the SBP |
| MAC Address | | | Responder |
| SBP Request | Variable | As described in SBP | Carries the frame body of the SBP |
| Information | | Request frame | Request frame except the first two |
| | | | fields (Category and Action). |

Table 3 below shows the contents of a SBP Response frame for a SBP Response TLV format.

TABLE 3

| Field / Name | Length | Value | Description |
|---|---|---|---|
| tlvType | 1 octet | 0xE1 | SBP Response TLV. |
| tlvLength | 2 octets | 1 | Number of Octets in ensuing field. |
| tlvValue | | | |
| SBP Initiator | 6 octets | variable | MAC Address of the SBP Initiator |
| MAC Address | | | |
| SBP Responder | 6 octets | variable | MAC Address of the SBP Responder |
| MAC Address | | | |
| SBP Response | Variable | As described in SBP | Carries the frame body of the SBP |
| Information | | Response frame | Response frame except the first two |
| | | | fields (Category and Action). |

Table 4 below shows the contents of a SBP Report frame for a SBP Report TLV format.

TABLE 4

| Field / Name | Length | Value | Description |
|---|---|---|---|
| tlvType | 1 octet | 0xE2 | SBP Report TLV. |
| tlvLength | 2 octets | 1 | Number of Octets in ensuing field. |
| tlvValue | | | |
| SBP Initiator | 6 octets | variable | MAC Address of the SBP Initiator |
| MAC Address | | | |
| SBP Responder | 6 octets | variable | MAC Address of the SBP Responder |
| MAC Address | | | |
| SBP Report | Variable | As described in | Carries the frame body of the SBP |
| Information | | SBP Report frame | Report frame except the first two fields |
| | | | (Category and Action). |

Table 5 below shows the contents of a SBP Termination frame for a SBP Termination TLV format.

TABLE 5

| Field / Name | Length | Value | Description |
|---|---|---|---|
| tlvType | 1 octet | 0xE3 | SBP Termination TLV. |
| tlvLength | 2 octets | 1 | Number of Octets in ensuing field. |
| tlvValue | | | |
| SBP Initiator | 6 octets | variable | MAC Address of the SBP Initiator |
| MAC Address | | | |
| SBP Responder | 6 octets | variable | MAC Address of the SBP Responder |
| MAC Address | | | |
| SBP | Variable | As described in | Carries the frame body of the SBP |
| Termination | | SBP Termination | Termination frame except the first two |
| Information | | frame | fields (Category and Action). |

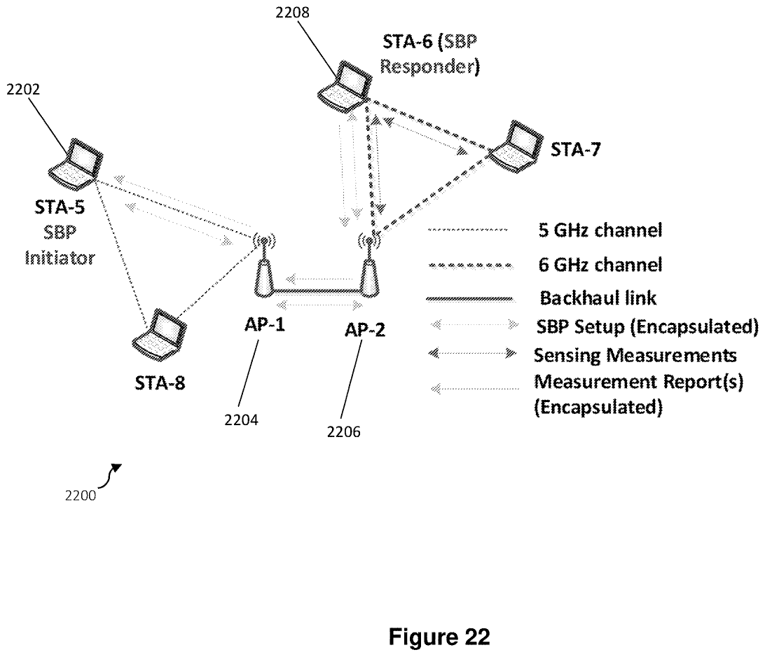

In an embodiment, the SBP Responder may be a non-AP STA (or a non-AP MLD). The non-AP STA supports SBP procedure as an SBP Responder, i.e., it is SBP Responder capable. Referring to illustration 2200 of FIG. 22, AP-1 2204 and AP-2 2206 are not SBP capable, but STA-6 2208 is SBP Responder capable. SBP Initiator (STA-5 2202) requests STA-6 2208 to act as the SBP Responder and perform sensing measurements on its behalf. STA-6 2208, acting as Sensing Initiator, performs sensing on two links (STA6-AP-2, and STA-6-STA-7) on behalf of STA-5 2202. SBP frames are encapsulated in Ethertype 89-0d Data frames and the SBP Responder may be any non-AP STA (e.g., such as STA-7) addressed by the Address 3 (A3) field of the Data frame that encapsulates the SBP Request frame. The encapsulated SBP frames are forwarded by the intermediate AP(s) (e.g., AP-1 2204, AP-2 2206) following the baseline rules regarding forwarding of Data frames. The AP with which the SBP Responder is associated with (e.g., the associated AP, such as AP-2 2206), may or may not be 11bf capable, and the other intermediate APs (e.g., AP-1 2204) need not even be 11bf capable. Advantageously, SBP can be achieved even when none of the AP(s) support SBP.

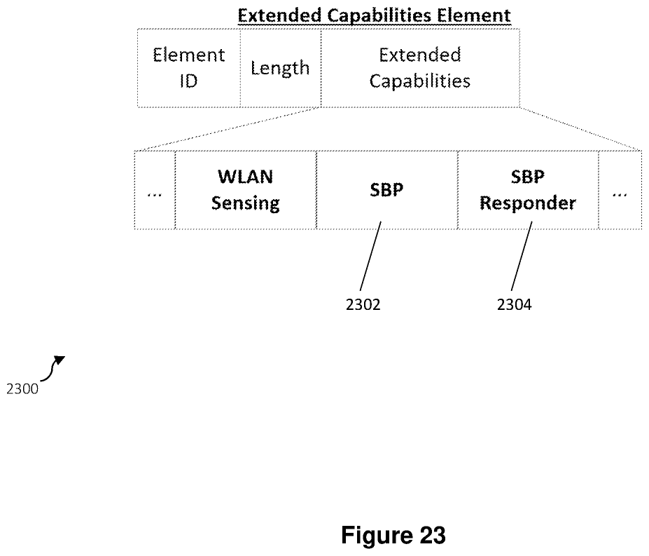

FIG. 23 depicts an example illustration of an Extended Capabilities Element 2300 for use in the SBP procedure of FIG. 22. The Extended Capabilities Element 2300 may comprise, in an Extended Capabilities field, a SBP Responder subfield 2304 indicating whether SBP Responder role is supported. For example, a value of ‘0’ indicates that the SBP Responder role is not supported, while a value of ‘1’ indicates that SBP Responder role is supported. Further, a SBP subfield bit 2302 in the Extended Capabilities field may indicate a non-AP STA's capability to assume the role of SBP Initiator.

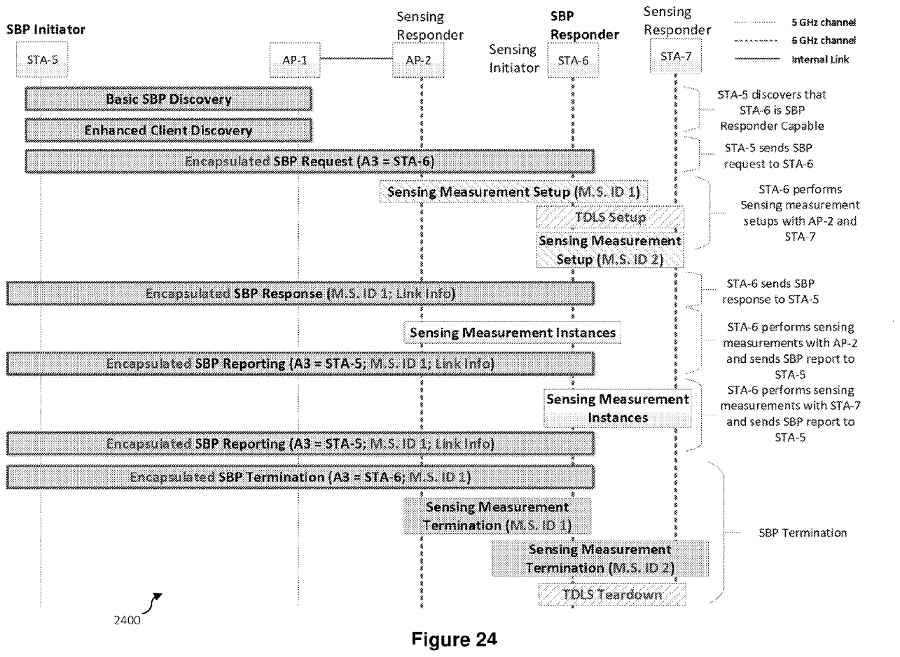

FIG. 24 shows an exemplary flowchart 2400 illustrating an overview of the SBP procedure of illustration 2200. As mentioned above, the non-AP STA-6 2208 acts as the SBP Responder. After Basic SBP Discovery and Enhanced Client Discovery are performed, the SBP Initiator STA-5 2202 discovers that STA-6 is SBP Responder capable. STA-5 2202 sets the A3 (DA) field of an Encapsulated SBP Request to STA-6 2208 (in A3) and transmits the Encapsulated SBP Request to STA-6 2208.

STA-6 2208 then performs Sensing Measurement Setup with AP-2 2206 (e.g., with M.S. ID=1) and STA-7 (e.g., with M.S. ID=2). Upon receiving the encapsulated SBP Request, Tunneled Direct link setup (TDLS) and TDLS PeerKey Security may also be performed between the non-AP STA SBP Responder and another non-AP STA prior to any sensing measurement setups. Thereafter, STA-6 2208 transmits an encapsulated SBP Response frame (e.g., with M.S. ID=1 and link information) to STA-5 2202. STA-6 2208 performs sensing measurements with AP-2 2206 and sends a corresponding encapsulated SBP report (e.g., with A3=STA-5, M.S. ID=1, and link information corresponding to the sensing measurements) to STA-5 2202. STA-6 2208 also performs sensing measurements with STA-7 and sends a corresponding encapsulated SBP report (e.g., with A3=STA-5, M.S. ID=1, and link information corresponding to the sensing measurements) to STA-5 2202.

To terminate the SBP procedure, an encapsulated SBP Termination frame (e.g., with A3 field set to STA-6 2208, and M.S. ID=1) may be transmitted from STA-5 2202 to STA-6 2208. STA-6 2208 accordingly sends Sensing Measurement Termination instructions to AP-2 2206 (e.g., with M.S. ID=1) and STA-7 (e.g., with M.S. ID=2). Thereafter, TDLS Teardown may be performed.

If the associated AP (e.g., AP-2 2206) is 11bf capable, the non-AP STA SBP Responder (STA-6 2208) can perform sensing on the link with the AP. Otherwise, it may only perform sensing measurements with other 11bf capable non-AP STAs. In an encapsulated SBP Request frame and encapsulated SBP Termination frame, the A3 field (DA) indicates the non-AP STA (STA-6 2208) that is requested to be the SBP Responder and if the non-AP STA is not associated with the AP identified by the A1 field (RA) (e.g., AP-1 2204), the frame is forwarded to the AP with which the non-AP STA is associated with (e.g., AP-2 2206) and the A4 field (SA) carries the SBP Initiator's address. When the frame is transmitted to the SBP Responder by the AP with which the SBP Responder is associated with (e.g., AP-2 2206), the A3 field (SA) carries the SBP Initiator's address. Similarly, in the reverse direction (e.g., in an encapsulated SBP Response frame, or an encapsulated SBP Report frame), when an AP is the receiver, the A3 field (DA) carries the SBP Initiator's address and the A4 field (SA) carries the SBP Responder's (STA-6 2208) address.

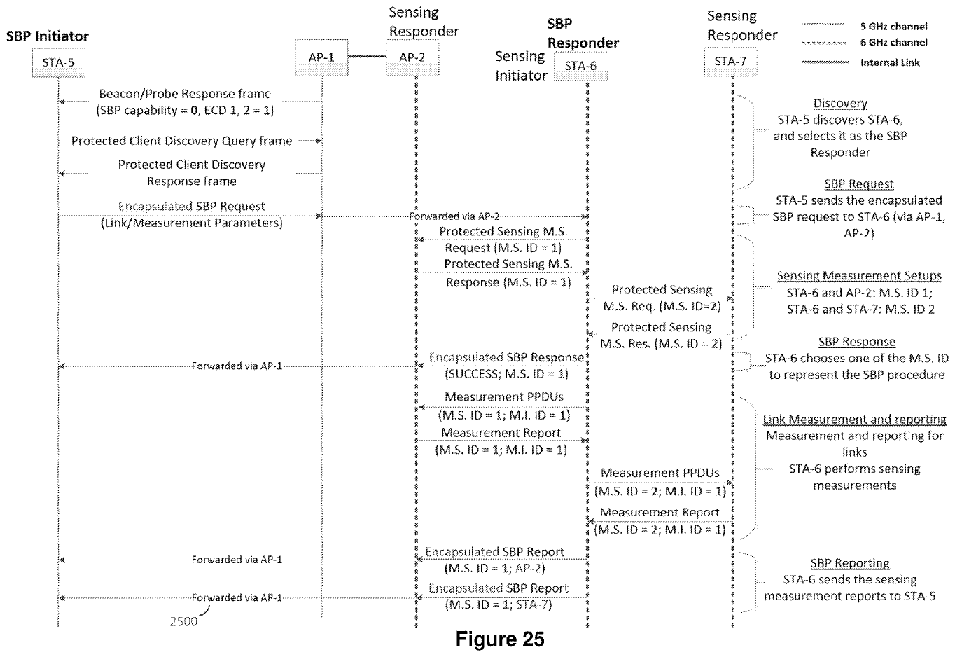

FIG. 25 shows an exemplary flowchart illustrating a signaling overview of the SBP procedure of flowchart 2400. In the discovery phase, STA-5 2202 discovers STA-6 2208 (e.g., through Beacon/Probe Response frames and Client Discovery Response frames) and selects it as the SBP Responder. STA-5 2202 may transmit a Protected Client Discovery Query frame to AP-1 2204, and the AP-1 2204 may respond by transmitting a Protected Client Discovery Response frame (e.g., comprising a list of the AP's associated STAs and neighboring STAs) to STA-5 2202.

In the SBP setup phase, STA-5 2202 sets the A3 (DA) field of an encapsulated SBP Request to STA-6 2208, and transmits the Encapsulated SBP Request to AP-1 2204 which forwards it to the STA-6 2208 via AP-2 2206. Sensing Measurement Setup is then performed between STA-6 2208 and AP-2 2206. For example, STA-6 2208 transmits a Protected Sensing M.S. Request with M.S. ID=1 to AP-2 2206, which then responds by transmitting a Protected Sensing M.S. Response with M.S. ID=1 to STA-6 2208. Sensing Measurement Setup is also performed between STA-6 2208 and STA-7. For example, STA-6 2208 transmits a Protected Sensing M.S. Request with M.S. ID=2 to STA-7, which then responds by transmitting a Protected Sensing M.S. Response with M.S. ID=2 to STA-6 2208. Thereafter, STA-6 2208 chooses one of the M.S. ID to represent the SBP procedure, and transmits an encapsulated SBP Response frame to STA-5 2202 via AP-1 2204 (e.g., encapsulated SBP Response frame with A3 field set to STA-5 2202, status code=SUCCESS, M.S. ID=1).

Sensing Measurement Instances (e.g., I2R, R2I and R2R) may then be performed, for example by STA-6 2208 sending measurement PPDUs (e.g., indicating M.S. ID=1 and M.I. ID=1) to AP-2 2206 and receiving a measurement report (e.g., indicating M.S. ID=1 and M.I. ID=1) from AP-2 2206 in response to the measurement PPDUs, and by STA-6 2208 sending measurement PPDUs (e.g., indicating M.S. ID=2 and M.I. ID=1) to STA-7 and receiving a measurement report (e.g., indicating M.S. ID=2 and M.I. ID=1) from STA-7 in response to the measurement PPDUs. STA-6 2208 then transmits encapsulated SBP Report frames (e.g., an encapsulated SBP Report frame with M.S. ID=1, indicating STA-7 for the sensing reports from STA-7, and another encapsulated SBP Report frame with M.S. ID=1, indicating AP-2 2206 for the sensing reports from AP-2 2206) to STA-5 2202 via AP-1 2204.

When transmitting encapsulated SBP Response frames or encapsulated SBP Report frames to AP-2 2206 for forwarding to STA-5 2202 (via AP-1 2204), the SBP Responder (STA-6 2208) sets the A3 (DA) field of the encapsulated SBP Response frames and encapsulated SBP Report frames to STA-5 2202. Further, the Sensing Initiator (also STA-6 2208) may perform conversion of M.S. IDs (if needed) and add link information to the measurement report(s) before transmitting the encapsulated SBP Report frames. Although not shown in the figure, a P2P negotiation (e.g., Tunneled Direct link setup (TDLS)) may be performed between the non-AP STA SBP Responder and another non-AP STA prior to any sensing measurement setups and subsequent sensing measurements and reporting between the non-AP STAs. Upon termination of the SBP procedure, the P2P negotiation (e.g., TDLS link) may be torn down as well. The A3 field (DA) value (STA-5 2202) in the encapsulated SBP Response frame and the encapsulated SBP Report frame in the figure is only applicable when the receiver is an AP (AP-1 2204 or AP-2 2206). When forwarded by AP-2 2206 to AP-1 2204, the A4 field (SA) carries the address of SBP Responder (STA-6 2208). When transmitted by AP-1 2204 (to STA-5 2202), the A3 field (SA) carries the address of SBP Responder (STA-6 2208).

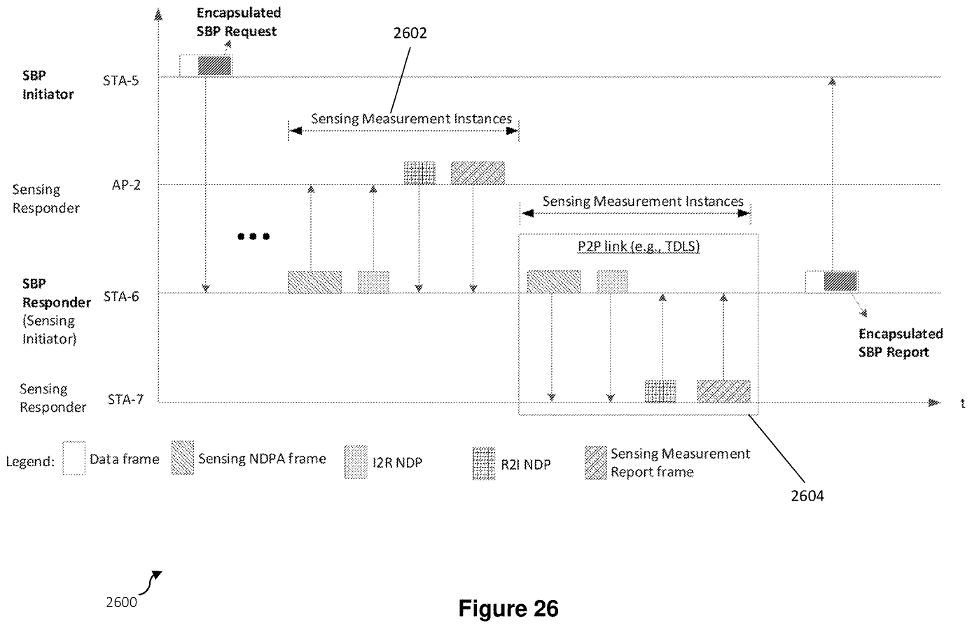

FIG. 26 depicts an example illustration 2600 of a Sensing Measurement Instance (e.g., for Non-TB sensing measurement) that may be utilized in flowchart 2400. For example, SBP Responder (STA-6 2208) performs non-TB sensing measurements with AP-2 2206 (see Sensing Measurement Instances 2602) and STA-7 (see Sensing Measurement Instances 2604). The Sensing measurements with STA-7 takes place over the TDLS link. For brevity, SBP Response, Sensing measurement setup etc. are not shown in the illustration 2600. Upon receiving an SBP Request, prior to any sensing measurement setups, if a P2P link doesn't already exist with STA-7, the SBP Responder (STA-6 2208) initiates a P2P link, e.g., a Tunneled Direct link setup (TDLS) and TDLS PeerKey Security with STA-7. All subsequent communication between STA-6 and STA-7 occurs over the TDLS link.

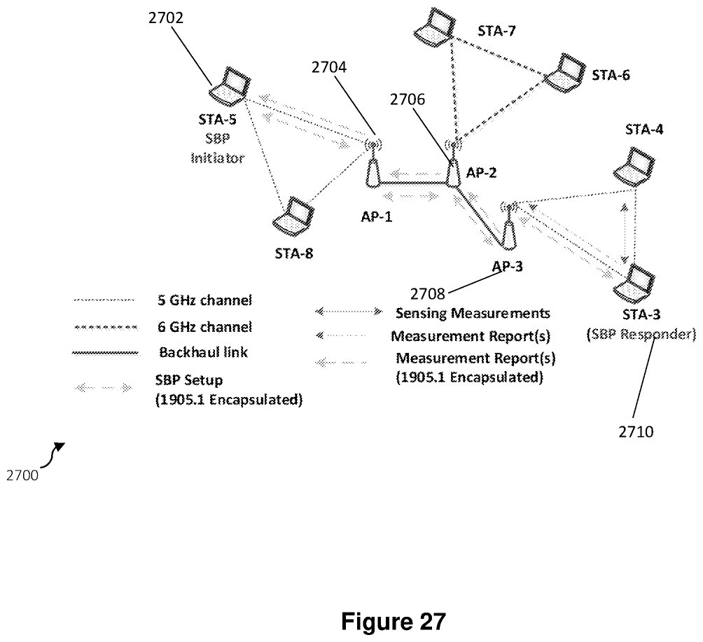

In an embodiment, 1905.1 SBP messages may be used to encapsulate SBP frames from start to end, i.e., from the SBP Initiator to SBP Responder. It is assumed that both the SBP Initiator and SBP Responder as well as any intermediate APs support the 1905.1 SBP messages. The APs may be part of an AP network, e.g., an EasyMesh AP network. Referring to illustration 2700 of FIG. 27, the SBP Responder may an AP (e.g., AP-3 2708) or a non-AP STA (e.g., STA-3 2710) as indicated by a SBP Responder MAC Address field of a SBP Request TLV (e.g., as shown in Tables 2-5 above). AP-1 2704, AP-2 2706 and AP-3 2708 are not SBP capable, but STA-3 2710 is SBP Responder capable. SBP Initiator (STA-5 2702) requests STA-3 2710 to act as the SBP Responder and perform sensing measurements on its behalf. STA-3 2710, acting as Sensing Initiator, performs sensing on two links (STA3-AP-3, and STA-3-STA-4) on behalf of STA-5 2702. The AP with which the SBP Responder (when it is a non-AP STA) is associated with (i.e., the associated AP, e.g., AP-3 2708), may or may not be 11bf capable. Further, the other intermediate APs (e.g., AP-1 2704, AP-2 2706) need not even be 11bf capable. This advantageously enables simpler operation since the same protocol (1905.1) is used to encapsulate the SBP messages.

When transmitted over the air (e.g., between non-AP STA and associated AP), the 1905.1 SBP messages are encapsulated using 802.11 data frames as shown in illustration 950 in FIG. 9B. For example, Address 2 (A2) field 952 is set to SBP (e.g., value=0x8036) and 1905.1 Protocol TLVs (SBP) field 958 is set in accordance with values indicated in Tables 2-5. When transmitted over wired interfaces (e.g., between two APs), the 1905.1 SBP messages are encapsulated in appropriate Layer 2 packets (e.g., Ethernet) and the format is as described in FIG. 21.

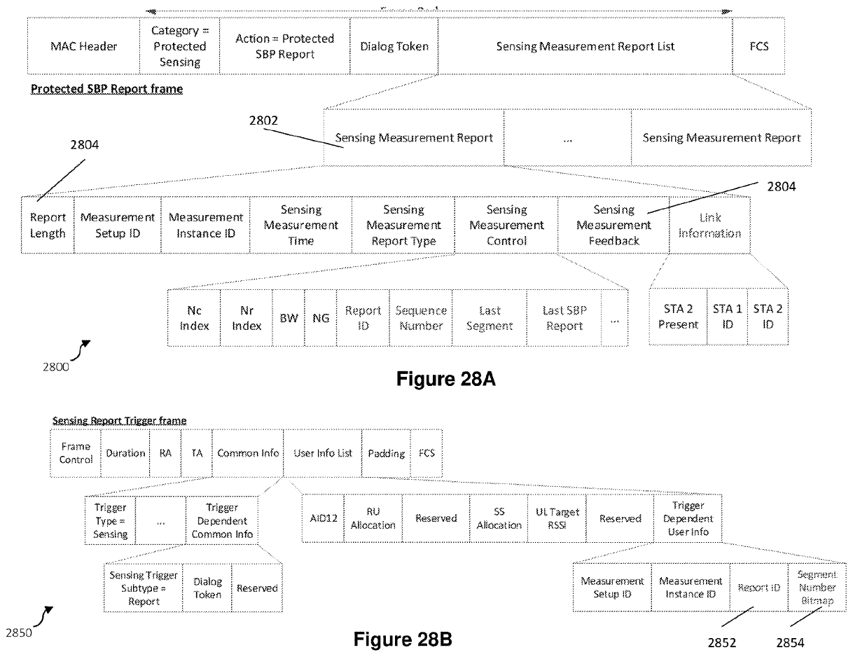

FIG. 28A depicts an alternate example illustration of a Protected SBP Report frame according to various embodiments of the present disclosure. The SBP Report frame 2800 may carry one or more Sensing measurement Reports 2802, each carrying a Sensing Measurement Feedback field 2804 containing the whole or a segment of the CSI measurement results for a link. The Report length field 2804 indicates the length (in octets) of the Sensing Measurement Report field 2802 and is large enough (e.g., 2 octets) to signal the largest possible Sensing Measurement Report field. The rest of the fields are as described in FIG. 15B. While FIG. 28A depicts a Protected SBP Report frame, the same format may also be used for the Protected Sensing Measurement Report frame to report the results of sensing measurements between a sensing receiver and a sensing initiator, except that the Action field of the frame is set as Protected Sensing Measurement Report instead of Protected SBP Report. At times, it is possible that a sensing measurement feedback (i.e., CSI measurement feedback) is too big (e.g., larger than 11450 octets) causing the host frame (e.g., the SBP Report frame or the Protected Sensing Measurement Report frame) to exceed the maximum MPDU size (11454 octets). In such cases, the CSI measurement feedback (identified by the Report ID) is divided into two or more segments of same size, except for the last segment, each segment identified by a unique Sequence Number and carried in a different Sensing Measurement Report field 2802. In the event that one or more segments of a sensing measurement report is not received by the sensing initiator during a TB sensing measurement instance, the sensing initiator may transmit a Sensing Report Trigger frame 2850 as illustrated in FIG. 28B to selectively solicit the lost segments. The Report ID field 2852 indicates the ID of the sensing measurement report while the Segment Number Bitmap field 2854 carries a bitmap (e.g., 16 bits), each bit set to 1 (starting from the first bit B0 for the first segment) indicating the Sequence Number (SN) of the segment requested for retransmission, e.g., bits 3, 5 set to 1 indicates that segments with SN=3 and 5 are requested for retransmission.

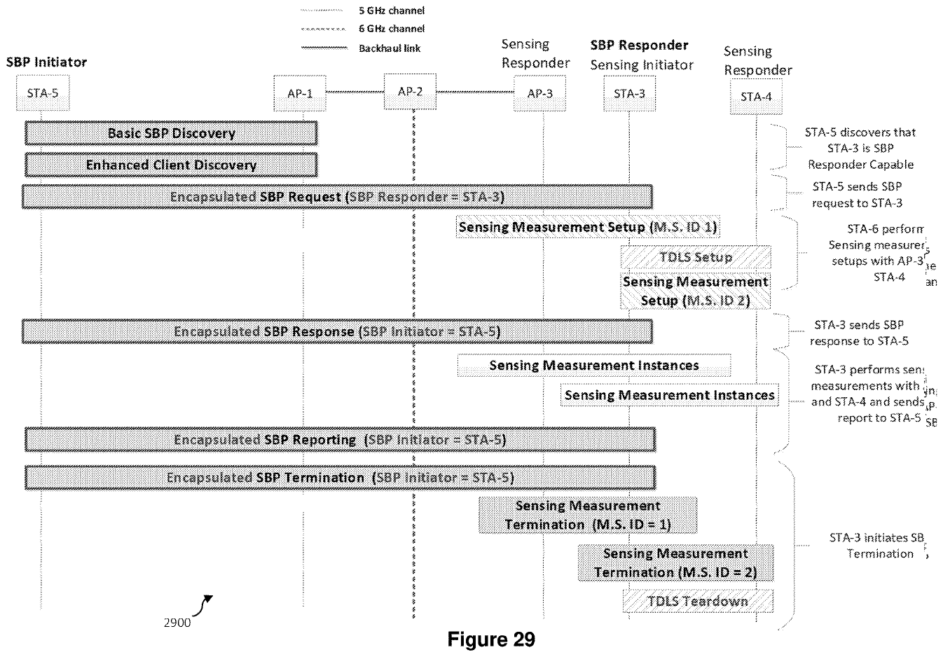

FIG. 29 shows an exemplary flowchart 2900 illustrating an overview of the SBP procedure of illustration 2700. The non-AP STA-3 2710 acts as the SBP Responder (and not an AP). After Basic SBP Discovery and Enhanced Client Discovery are performed, the SBP Initiator STA-5 2702 discovers that STA-3 2710 is SBP Responder capable. STA-5 2702 transmits an Encapsulated SBP Request to STA-3 2710.

STA-3 2710 then performs Sensing Measurement Setup with AP-3 2708 (e.g., with M.S. ID=1) and STA-4 (e.g., with M.S. ID=2). Upon receiving the encapsulated SBP Request, Tunneled Direct link setup (TDLS) and TDLS PeerKey Security may also be performed between the non-AP STA SBP Responder and another non-AP STA prior to any sensing measurement setups. Thereafter, STA-3 2710 transmits an encapsulated SBP Response frame to STA-5 2702. STA-3 2710 performs sensing measurements with AP-3 2708 and sends a corresponding encapsulated SBP report to STA-5 2702. STA-3 2710 also performs sensing measurements with STA-4 and sends a corresponding encapsulated SBP report to STA-5 2702.

To terminate the SBP procedure, an encapsulated SBP Termination frame may be transmitted from STA-3 2710 to STA-5 2702. STA-3 2710 accordingly sends Sensing Measurement Termination instructions to AP-3 2708 (e.g., with M.S. ID=1) and STA-4 (e.g., with M.S. ID=2). Thereafter, TDLS Teardown may be performed.

If the associated AP (e.g., AP-3 2708) is 11bf capable, the non-AP STA SBP Responder (STA-3 2710) can perform sensing on the link with the AP. Otherwise, it may only perform sensing measurements with other 11bf capable non-AP STAs (e.g., STA-4). A main difference between the SBP procedure of flowchart 2800 and flowchart 1800 is that communications between STA-5 2702 and STA-3 2710 are under end-to-end encapsulation.

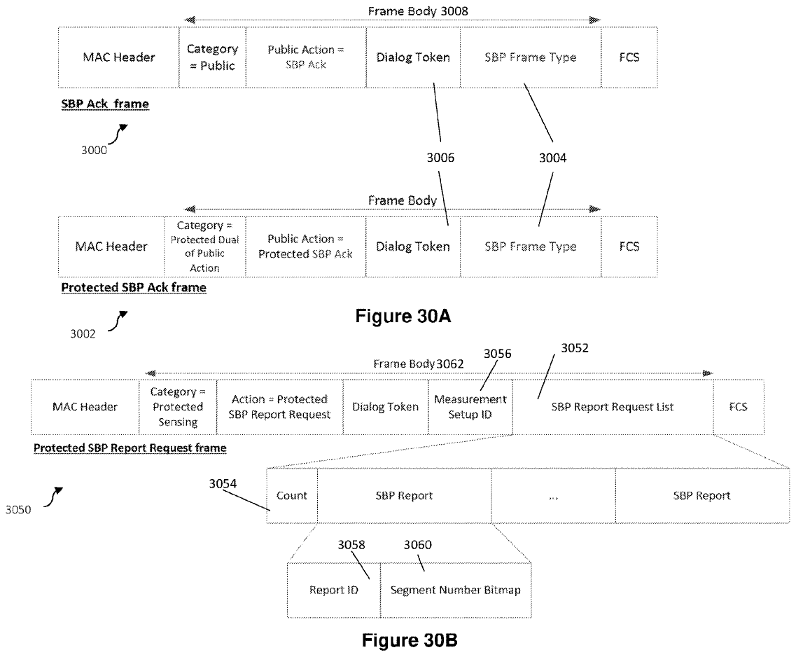

FIG. 30A depicts an example illustration of a SBP Ack frame 3000 and a Protected SBP Ack frame 3002 according to various embodiments. When the SBP Initiator and the SBP Responder are not directly connected over a Wireless Medium (WM), since the 802.11 Ack frame are not forwarded beyond the immediate BSS, at times it may be difficult to ascertain whether the SBP message has been delivered to the peer STA, leading to unnecessary timeouts or other similar issues. The SBP Ack frame 3000 (and its protected version, Protected SBP Ack frame 3002) can be used to acknowledge the receipt of any SBP message. In particular, the SBP Frame Type field 3004 indicates the type of the SBP frame that is acknowledged by the SBP Ack frame 3000 or 3002, for example by indicating a value corresponding to a SBP frame type as shown in table 6 below.

TABLE 6

| SBP Frame Type | Meaning |
|---|---|
| 0 | SBP Request |
| 1 | SBP Response |
| 2 | SBP Report |
| 3 | SBP Termination |
| 4~255 | Reserved |

Further, the Dialog Token field 3006 value may be copied from the Dialog Token field of the SBP frame being acknowledged. In the SBP Ack frame of some SBP frames that does not contain a Dialog Token field (e.g., a SBP Report frame), the Dialog Token may carry the Measurement Instance ID instead. The Dialog Token field 3006 uniquely identifies the SBP frame being acknowledged. A SBP Ack frame is encapsulated in a SBP Ethertype89-0d Data frame by including the Frame body 3008 in the payload field of a SBP Ethertype89-0d frame body.

A SBP Ack TLV carries the contents of an SBP Ack frame when carried in a 1905.1 message, for example in the SBP Ack TLV format as shown in Table 7 below.

TABLE 7

| Field / Name | Length | Value | Description |
|---|---|---|---|
| tlvType | 1 octet | 0xE4 | SBP Ack TLV. |
| tlvLength | 2 octets | 1 | Number of Octets in ensuing field. |
| tlvValue | | | |
| SBP Initiator MAC | 6 octets | variable | MAC Address of the SBP Initiator |
| Address | | | |
| SBP Responder MAC | 6 octets | variable | MAC Address of the SBP |
| Address | | | Responder |
| SBP Ack Information | Variable | As described in | Carries the frame body of the SBP |
| | | SBP Ack frame | Ack frame except the first two fields |
| | | | (Category and Action). |

FIG. 30B depicts an example illustration of a Protected SBP Report Request frame 3050 according to various embodiments. The Protected SBP Report Request frame can be used by the SBP Initiator to request the SBP Responder to transmit one or more SBP Reports corresponding to a Measurement Setup ID and/or Report ID, or selectively retransmit one or more segments of a SBP Report. A Protected SBP Report Request frame 3050 carries a Measurement Setup ID field 3056 indicating the Measurement Setup ID that represents the SBP procedure and a SBP Report Request List field 3052 that includes a Count field 3054 and one or more SBP Report fields, the Count field 3054 indicating the number of SBP Report fields included in the SBP Report Request List field. Each SBP Report field includes a Report ID field 3058 and a Segment Number Bitmap field 3060. The Report ID field 3058 indicates the ID of the SBP Report while the Segment Number Bitmap field 3060 carries a bitmap (e.g., 16 bits), each bit set to 1 (starting from the first bit B0 for the first segment) indicating the Sequence Number (SN) of the segment requested for retransmission, e.g., bits 3, 5 set to 1 indicates that segments with SN=3 and 5 are requested for retransmission. If the SBP Report Request frame does not include the SBP Report Request list, it indicates that the SBP Initiator is requesting the SBP Responder to transmit any available SBP Report. A SBP Report Request frame is encapsulated in a SBP Ethertype89-0d Data frame by including the Frame body 3062 in the payload field of a SBP Ethertype89-0d frame body.

A SBP Report Request TLV carries the contents of an SBP Ack frame when carried in a 1905.1 message, for example in the SBP Report Request TLV format as shown in Table 8 below.

TABLE 8

| Field / Name | Length | Value | Description |
|---|---|---|---|
| tlvType | 1 octet | 0xE4 | SBP Report Request TLV. |
| tlvLength | 2 octets | 1 | Number of Octets in ensuing field. |
| tlvValue | | | |
| SBP Initiator | 6 octets | variable | MAC Address of the SBP Initiator |
| MAC Address | | | |
| SBP Responder | 6 octets | variable | MAC Address of the SBP |
| MAC Address | | | Responder |
| SBP Report | Variable | As described | Carries the frame body of the SBP |
| Request | | in SBP | Report Request frame except the |
| Information | | Report | first two fields (Category and |
| | | Request frame | Action). |

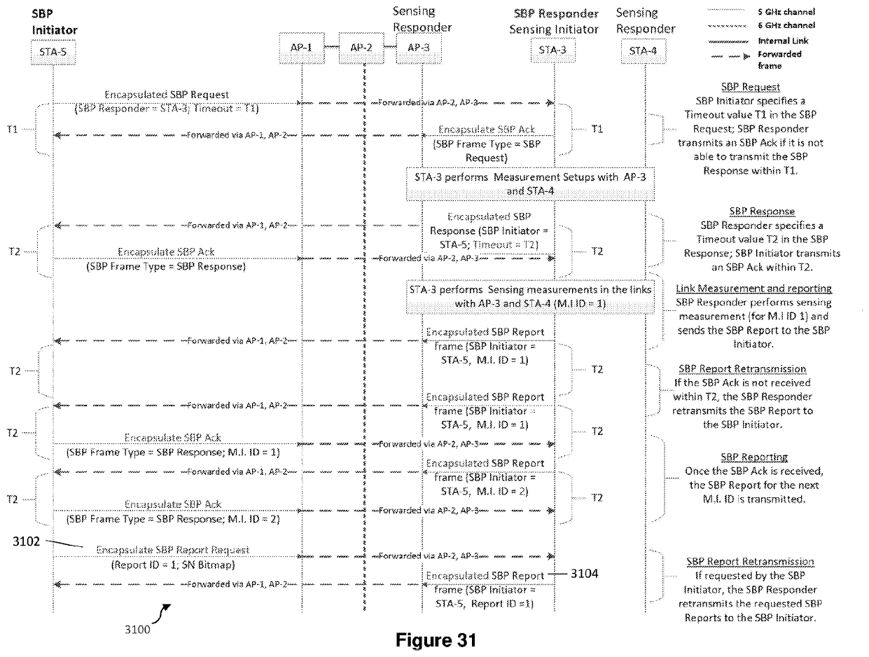

An example of how the SBP Ack and the SBP Report Request may be utilized is shown in flowchart 3100 of FIG. 31. The SBP Initiator may specify a Timeout value T1 in the SBP Request frame, so that the SBP Responder has to transmit an SBP Ack frame to the SBP Initiator if it is not able to transmit the SBP Response within T1. Further, the SBP Responder may specify a Timeout value T2 in the SBP Response frame, so that the SBP Initiator has to transmit an SBP Ack frame to the SBP Responder within T2. During Link Measurement and reporting, the SBP Responder performs sensing measurement (e.g., for M.I. ID=1) and sends the SBP Report to the SBP Initiator. If the SBP Ack is not received within T2, the SBP Responder retransmits the SBP Report to the SBP Initiator. Once the SBP Ack is received, the SBP Report for the next M.I. ID is transmitted. The Timeout values (T1, T2) may be carried in the SBP Request and SBP Response respectively, and can be of a same or different duration, or they may be a constant value specified by the 802.11 specification. If no response is received for an SBP frame/message within the specified timeout duration from the peer STA, the transmitter (the SBP Initiator or the SBP Responder) may choose to retransmit the SBP frame after an implementation-dependent period of time; if a response is still not received, the SBP procedure may be torn down and all allocated resources for the SBP procedure maybe released. The SBP Initiator (STA-5) may also request the SBP Initiator (STA-3) to retransmit one or more segments of a SBP Report by transmitting an SBP Report Request 3102 indicating the requested Report ID and the requested Sequence Numbers of the segments. This may be used, for example, when some segments of an SBP Report are not received properly. Upon receiving the SBP Report Request, the SBP Responder retransmits the requested segments of the SBP Report 3104. Although the example above illustrates the case where the SBP Initiator and SBP Responder do not have direct WM connection, SBP Ack frames may also be used when both are part of the same BSS (e.g., when the SBP Initiator and SBP Responder have direct WM connection).

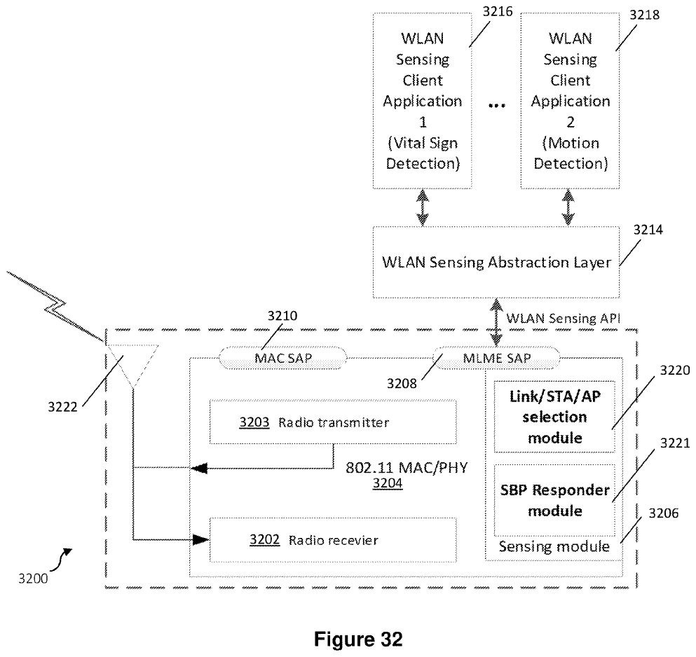

FIG. 32 shows an example configuration of a non-AP communication apparatus 3200. The communication apparatus 3200 is implemented as a STA for tunneled sensing by proxy in accordance with various embodiments of the present disclosure. The communication apparatus 3200 may include at least one radio transmitter 3203 and at least one radio receiver 3202 in collaboration with at least one antenna 3222 (for the sake of simplicity, only one radio transmitter, radio receiver and antenna are shown in FIG. 32) for transmission and reception of signals, respectively. The communication apparatus 3200 further comprises circuitry 3204 implementing 802.11 MAC/PHY sublayer functions (the 802.11 MAC/PHY sublayers 3204) which comprises a Sensing module 3206 for channel measurements; layer management service interfaces such as MLME SAP 3208 and MAC SAP 3210 through which defined primitives are exchanged to pass information and layer management functions such as WLAN sensing may be invoked; and higher layer applications (e.g., WLAN Sensing Abstraction Layer 3214) communicating with the 802.11 MAC/PHY 3204 through MLME SAP 3208.

Further, the 802.11 MAC/PHY sublayers 3204 may communicate with WLAN Data Applications (not shown) through MAC SAP 3210. In this example, the Sensing module 3206 performs channel measurements and provides raw results to WLAN Sensing Abstraction Layer 3214 via WLAN Sensing API. The WLAN Abstraction Layer 3214 collects and consolidates the channel measurement results from 802.11 device and may process the results (e.g., smoothing compression etc.) before passing the processed results to WLAN Sensing Client Applications like WLAN Sensing Client Application 1 (Vital Sign Detection) 3216 and WLAN Sensing Client Application 2 (Motion Detection) 3218. The WLAN Sensing Client Applications like 3216, 3218 may perform WLAN Sensing based on the channel measurements (e.g., using application specific machine learning algorithms etc.) and provides the results of the WLAN sensing, in this case, presence/absence of human detection and human motion detection.

The communication apparatus further comprises a layer-dependent entity Station Management Entity (SME) (not shown) which perform functions on behalf of general system management entities and would implement standard management protocol such as to ensure correct MAC operation. The layer-dependent entity provides interfaces such as MLME SAP 3208 and PLME SAP (not shown) for exchanging primitives and communicating with MLME and PLME, respectively.

The MAC/PHY Sublayer 3204 may be configured to receive information or WLAN sensing related MAC/PHY parameters to form an SBP request frame. The trigger frame or PPDU is then transmitted to one or more communication apparatuses (e.g., AP or SBP Responder), via at least one radio transmitter 3203 through the antenna 3222.

The MAC/PHY Sublayer 3204 may also be configured to unpack response or measurement PPDU, e.g., SBP Response frame and SBP Report frame received from another communication apparatus, and pass the information related to the received PPDU to the Sensing module 3206.

The Sensing module 3206 comprises a Link/STA/AP selection module 3220 configured to select one or more links, STAs and/or APs to participate in the SBP procedure. The selection may be included in the frames, for example, as Target STAs/Links or Target APs information. The Sensing module 3206 further comprises a SBP Responder Module 3221 configured to generate responses for SBP related communications that may be received from other STAs/APs.

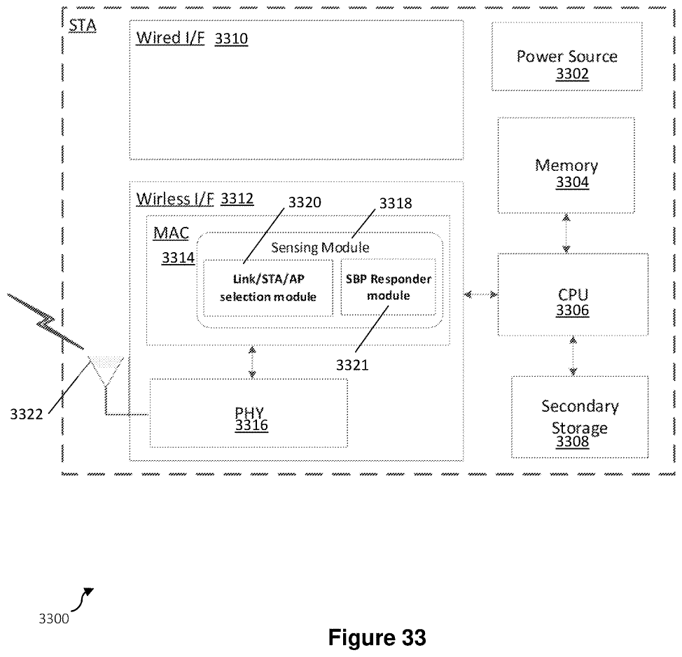

FIG. 33 shows another example configuration of a communication apparatus 3300. The communication apparatus 3300 is implemented as a non-AP STA for tunneled sensing by proxy in accordance with various embodiments of the present disclosure. The communication apparatus 3300 comprises a power source 3302, a memory 3304, a central processing unit (CPU) 3306 comprising at least one processor, a secondary storage 3308, a wired interface (I/F) 3310 and a wireless I/F 3312. The memory 3304 may be a non-transitory computer-readable storage medium having stored therein data representing instructions executable by the at least one processor of the CPU 3306 to communicate with the wireless I/F 3312 to perform enhanced client discovery procedure according to various embodiments described in the present disclosure. The Wireless I/F 3312 comprises a MAC layer 3314 and a PHY layer 3316. The PHY layer 3316 connects with a radio transmitter (not shown), a radio receiver (not shown) and an antenna 3322 used for transmitting/receiving signals to/from other communication apparatuses (e.g., STAs/APs). Alternatively, the communication apparatus 3300 may transmit/receive signals to/from other communication apparatus (e.g., STAs) via the Wired I/F 3310. The secondary storage 3308 may be configured to store AIDs of associated communication apparatus.

The MAC layer 3314 further comprises a Sensing Module 3318. The Sensing Module 3318 configured to generate and process frames (e.g., client discovery query/response frames, authorization validation request/response frames, report frames) to perform SBP procedures (e.g., as SBP initiator/responder) according to various embodiments described above. The Sensing Module 3318 comprises a Link/STA/AP selection module 3320 which is configured to select one or more links, STAs and/or APs to participate in the SBP procedure. The selection may be included in the frames, for example, as Target STAs/Links or Target APs information. The Sensing module 3318 further comprises a SBP Responder Module 3321 configured to generate responses for SBP related communications that may be received from other STAs/APs.

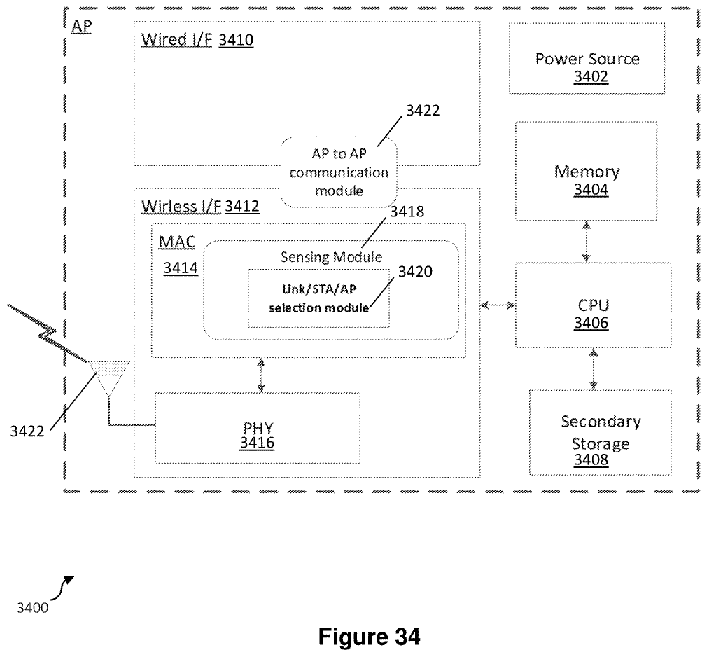

FIG. 34 shows another example configuration of a communication apparatus 3400. The communication apparatus 3400 is implemented as an AP for tunneled sensing by proxy in accordance with the present disclosure. The communication apparatus 3400 comprises a power source 3402, a memory 3404, a central processing unit (CPU) 3406 comprising at least one processor, a secondary storage 3408, a wired I/F 3410 and a wireless I/F 3412. The memory 3404 may be a non-transitory computer-readable storage medium having stored therein data representing instructions executable by the at least one processor of the CPU 3406 to communicate with the wireless I/F 3412 to perform multi-generation random access according to various embodiments in the present disclosure. The Wireless I/F 3412 comprises a MAC layer 3414 and a PHY layer 3416. The PHY layer 3416 connects with a radio transmitter (not shown), a radio receiver (not shown) and an antenna 3422 used for transmitting/receiving signals to/from other (base) communication apparatuses. Alternatively, the communication apparatus 3400 may transmit/receive signals to/from other communication apparatus via the Wired I/F 3410.

The MAC layer 3414 further comprises a Sensing Module 3418. The Sensing Module 3418 configured to generate and process frames (e.g., client discovery query/response frames, authorization validation request/response frames, report frames) to perform SBP procedures (e.g., as SBP responder, sensing initiator, or sensing responder) according to various embodiments described above. The Sensing Module 3418 comprises a Link/STA/AP selection module 3420 which is configured to select one or more links, STAs and/or other APs to participate in the SBP procedure. The selection may be included in the frames, for example, as Target STAs/Links or Target APs information in a sensing request transmitted to another AP.

An AP to AP Communication module 3422 facilitates communication between wired I/F 3410 and Wireless I/F 3412. For example, multiple APs may be connected through wired backhaul in the Wired I/F 3410 while the APs communicates with other STAs via Wireless I/F 3412. When receiving a frame (e.g., SBP request frame) from a non-AP STA via Wireless I/F 3412, the AP to AP Communication Module 3422 may be configured to forward the frame (or generate another frame with the information) to other co-located AP or other AP within the same MLD, or interconnected AP through the wired backhaul link in the Wired I/F 3410. Similarly, when receiving a frame (e.g., SBP request frame) from another AP via Wired I/F 3410, the AP to AP Communication Module 3422 may be configured to forward the frame (or generate another frame with the information) to a STA which connects to the communication apparatus 3400 wireless through Wireless IF 3412.

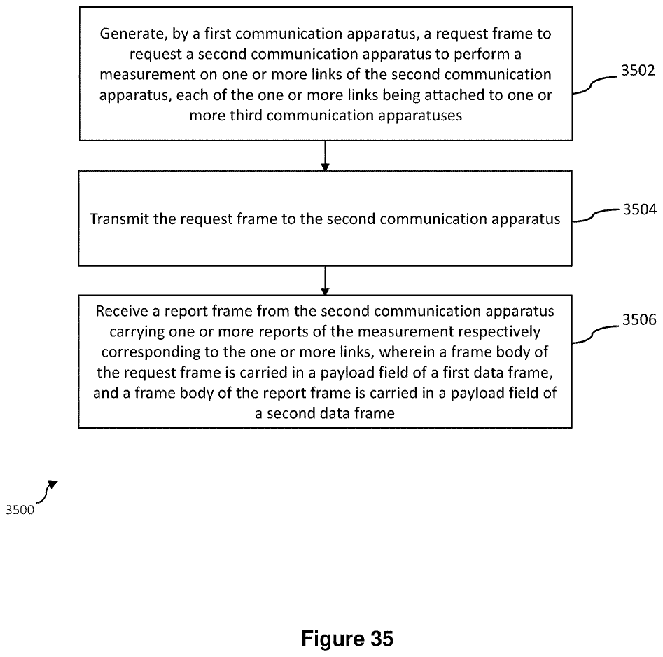

FIG. 35 shows a flow diagram 3500 illustrating a communication method according to various embodiments. At step 3502, a request frame is generated by a first communication apparatus to request a second communication apparatus to perform a measurement on one or more links of the second communication apparatus, each of the one or more links being attached to one or more third communication apparatuses. At step 3504, the request frame is transmitted to the second communication apparatus. At step 3506, a report frame is received from the second communication apparatus carrying one or more reports of the measurement respectively corresponding to the one or more links, wherein a frame body of the request frame is carried in a payload field of a first data frame, and a frame body of the report frame is carried in a payload field of a second data frame.

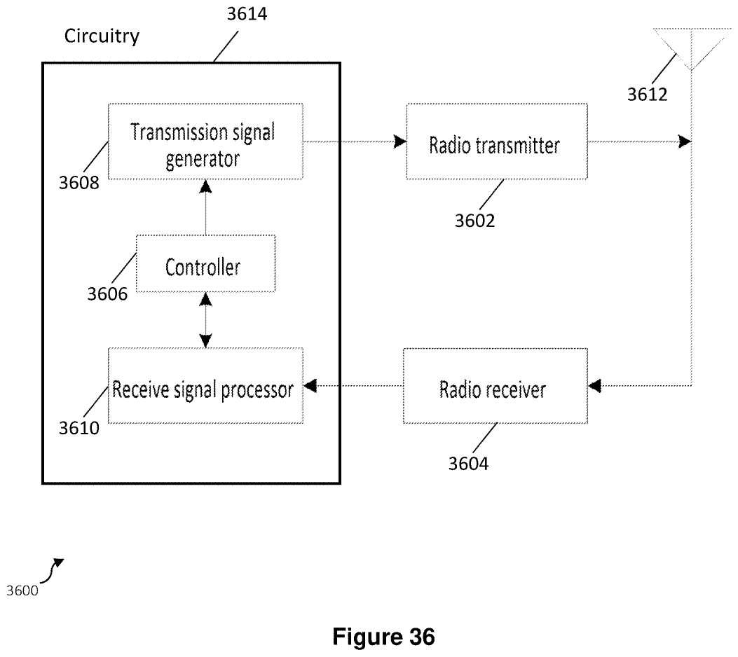

FIG. 36 shows a schematic, partially sectioned view of a communication apparatus 3600 that can be implemented for tunneled sensing by proxy in accordance with the various embodiments. The communication apparatus 3600 may be implemented as an STA or AP according to various embodiments.

Various functions and operations of the communication apparatus 3600 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 36, the communication apparatus 3600 may include circuitry 3614, at least one radio transmitter 3602, at least one radio receiver 3604 and multiple antennas 3612 (for the sake of simplicity, only one antenna is depicted in FIG. 36 for illustration purposes). The circuitry may include at least one controller 3606 for use in software and hardware aided execution of tasks it is designed to perform, including control of communications with one or more other devices in a wireless network. The at least one controller 3606 may control at least one transmission signal generator 3608 for generating frames to be sent through the at least one radio transmitter 3602 to one or more other STAs or APs and at least one receive signal processor 3610 for processing frames received through the at least one radio receiver 3604 from the one or more other STAs or APs. The at least one transmission signal generator 3608 and the at least one receive signal processor 3610 may be stand-alone modules of the communication apparatus 3600 that communicate with the at least one controller 3606 for the above-mentioned functions. Alternatively, the at least one transmission signal generator 3608 and the at least one receive signal processor 3610 may be included in the at least one controller 3606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3602, at least one radio receiver 3604, and at least one antenna 3612 may be controlled by the at least one controller 3606. Furthermore, while only one radio transmitter 3602 is shown, it will be appreciated that there can be more than one of such transmitters.

In various embodiments, when in operation, the at least one radio receiver 3604, together with the at least one receive signal processor 3610, forms a receiver of the communication apparatus 3600. The receiver of the communication apparatus 3600, when in operation, provides functions required for tunneled sensing by proxy. While only one radio receiver 3604 is shown, it will be appreciated that there can be more than one of such receivers.

The communication apparatus 3600, when in operation, provides functions required for tunneled sensing by proxy. For example, the communication apparatus 3600 may be a first communication apparatus. The circuitry 3614 may, in operation, generate a request frame to request a second communication apparatus to perform a measurement on one or more links of the second communication apparatus, each of the one or more links being attached to one or more third communication apparatuses, The transmitter 3602 may, in operation, transmit the request frame to the second communication apparatus. The receiver 3604 may, in operation, receive a report frame from the second communication apparatus carrying one or more reports of the measurement respectively corresponding to the one or more links, wherein a frame body of the request frame is carried in a payload field of a first data frame, and a frame body of the report frame is carried in a payload field of a second data frame.

The request frame may be a SBP Setup Request frame, and the first data frame or the second data frame may be an IEEE 802.11 Data frame or an IEEE 802.15.4 Data frame. The measurement may be a sensing measurement, and the report frame may be a SBP Report frame. The receiver 3604 may be further configured to receive a SBP Setup Response frame indicating if the SBP Setup Request is accepted, a frame body of the SBP Setup Response frame being carried in a payload field of a third data frame. The transmitter 3602 may be further configured to transmit a SBP Termination frame to the second communication apparatus to terminate a SBP procedure, or the receiver 3604 may be further configured to receive the SBP Termination frame from the second communication apparatus to terminate the SBP procedure, a frame body of the SBP Termination frame being carried in a payload field of a fourth data frame. The first communication apparatus and the one or more third communication apparatuses may be non-AP STAs, and the second communication apparatus may be an AP. The first communication apparatus and second communication apparatus may be non-AP STAs, and each of the one or more third communication apparatuses may be either an AP STA or a non-AP STA. The transmitter 3602 may be further configured to transmit a SBP Ack frame to the second communication apparatus to acknowledge the receipt of the SBP Response frame, the SBP Report frame or the SBP Termination frame, a frame body of the SBP Ack frame being carried in a payload field of a fifth data frame.

Each of the first data frame and the second data frame may be an Ethertype 89-0d data frame. The payload field of the first data frame and the payload field of the second data frame may be a 1905.1 message. The request frame may be configured to identify the second communication apparatus in an Address 3 (A3) field of the data frame carrying the frame body of the request frame. The request frame or the report frame may be configured to identify the second communication apparatus in a SBP Responder MAC Address field carried in the 1905.1 message.

Further, the communication apparatus 3600 may be a second communication apparatus. The receiver 3604 may, in operation, receive a request frame from a first communication apparatus to perform a measurement on one or more links of the second communication apparatus, the one or more links being attached to one or more third communication apparatuses. The circuitry 3614 may, in operation, perform the measurement. The transmitter 3602 may, in operation, transmit a report frame carrying one or more reports of the measurement corresponding to the one or more links, wherein a frame body of the request frame is carried in a payload field of a first data frame, and a frame body of the report frame is carried in a payload field of a second data frame.

The second communication apparatus may be an AP, and the first data frame or the second data frame may be an IEEE 802.11 Data frame or an IEEE 802.15.4 Data frame. The second communication apparatus may be a non-AP STA, and the transmitter 3602 may be further configured to transmit an indication that the second communication apparatus is capable of being a SBP Responder separately from an indication that the second communication apparatus is capable of being a SBP Initiator. The transmitter 3602 may be further configured to transmit a request to a fourth communication apparatus to perform measurements on one or more links of the fourth communication apparatus, each of the one or more links being attached to the one or more third communication apparatuses. Each of the first data frame and the second data frame may be an Ethertype 89-0d data frame, or the payload field of the first data frame and the payload field of the second frame is a 1905.1 message. The request frame may be a SBP Request frame, and the transmitter 3602 may be further configured to transmit an SBP Ack frame to the first communication apparatus to acknowledge the receipt of the SBP Request frame, a frame body of the SBP Ack frame being carried in a payload field of a fifth data frame. The report frame may be a SBP Report frame and the transmitter 3602 may be further configured to retransmit the SBP Report frame if an SBP Ack frame acknowledging the receipt of the SBP Report frame is not received from the first communication apparatus within a specified timeout duration.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for tunneled sensing by proxy.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
circuitry, which in operation, generates a request frame to request a second communication apparatus to perform a measurement on one or more links of the second communication apparatus, each of the one or more links being attached to one or more third communication apparatuses;
a transmitter, which in operation, transmits the request frame to the second communication apparatus; and
a receiver, which in operation, receives a report frame from the second communication apparatus carrying one or more reports of the measurement respectively corresponding to the one or more links, wherein a frame body of the request frame is carried in a payload field of a first data frame and a frame body of the report frame is carried in a payload field of a second data frame.

2. The first communication apparatus of claim 1, wherein the request frame is a Sensing By Proxy (SBP) Setup Request frame, and the first data frame or the second data frame is an IEEE 802.11 Data frame or an IEEE 802.15.4 Data frame.

3. The first communication apparatus of claim 1, wherein the measurement is a sensing measurement, and the report frame is a SBP Report frame.

4. The first communication apparatus of claim 2, wherein the receiver is further configured to receive a SBP Setup Response frame indicating if the SBP Setup Request is accepted, a frame body of the SBP Setup Response frame being carried in a payload field of a third data frame.

5. The first communication apparatus of claim 1, wherein the transmitter is further configured to transmit a SBP Termination frame to the second communication apparatus to terminate a SBP procedure, or the receiver is further configured to receive the SBP Termination frame from the second communication apparatus to terminate the SBP procedure, a frame body of the SBP Termination frame being carried in a payload field of a fourth data frame.

6. The first communication apparatus of claim 2, wherein the first communication apparatus and the one or more third communication apparatuses are non-Access Point (AP) stations (STAs), and the second communication apparatus is an AP.

7. The first communication apparatus of claim 2, wherein the first communication apparatus and second communication apparatus are non-Access Point (AP) stations (STAs), and each of the one or more third communication apparatuses is either an AP STA or a non-AP STA.

8. The first communication apparatus of claim 1, wherein each of the first data frame and the second data frame is an Ethertype 89-0d data frame.

9. The first communication apparatus of claim 1, wherein the payload field of the first data frame and the payload field of the second data frame is a 1905.1 message.

10. The first communication apparatus of claim 8, wherein the request frame is configured to identify the second communication apparatus in an Address 3 (A3) field of the data frame carrying the frame body of the request frame.

11. The first communication apparatus of claim 9, wherein the request frame or the report frame is configured to identify the second communication apparatus in a MAC Address field carried in the 1905.1 message.

12. The first communication apparatus of claim 3, wherein the transmitter is further configured to transmit an SBP Acknowledgement (Ack) frame to the second communication apparatus to acknowledge the receipt of the SBP Response frame, the SBP Report frame or the SBP Termination frame, a frame body of the SBP Ack frame being carried in a payload field of a fifth data frame.

13. A second communication apparatus comprising:
a receiver, which in operation, receives a request frame from a first communication apparatus to perform a measurement on one or more links of the second communication apparatus, the one or more links being attached to one or more third communication apparatuses;
circuitry, which in operation, performs the measurement; and
a transmitter, which in operation, transmits a report frame carrying one or more reports of the measurement corresponding to the one or more links, wherein a frame body of the request frame is carried in a payload field of a first data frame, and a frame body of the report frame is carried in a payload field of a second data frame.

14. The second communication apparatus of claim 13, wherein the second communication apparatus is an AP, and the first data frame or the second data frame is an IEEE 802.11 Data frame or an IEEE 802.15.4 Data frame.

15. The second communication apparatus of claim 13, wherein the second communication apparatus is a non-AP STA, and the transmitter is further configured to transmit an indication that the second communication apparatus is capable of being a SBP Responder separately from an indication that the second communication apparatus is capable of being a SBP Initiator.

16. The second communication apparatus of claim 14, wherein the transmitter is further configured to transmit a request to a fourth communication apparatus to perform measurements on one or more links of the fourth communication apparatus, each of the one or more links being attached to the one or more third communication apparatuses.

17. The second communication apparatus of claim 13, wherein each of the first data frame and the second data frame is an Ethertype 89-0d data frame, or the payload field of the first data frame and the payload field of the second data frame is a 1905.1 message.

18. The second communication apparatus of claim 13, wherein the request frame is a SBP Request frame, and the transmitter is further configured to transmit an SBP Ack frame to the first communication apparatus to acknowledge the receipt of the SBP Request frame, a frame body of the SBP Ack frame being carried in a payload field of a fifth data frame.

19. The second communication apparatus of claim 13, wherein the report frame is a SBP Report frame and the transmitter is further configured to retransmit the SBP Report frame if an SBP Ack frame acknowledging the receipt of the SBP Report frame is not received from the first communication apparatus within a specified timeout duration.

20. A communication method comprising:
generating, by a first communication apparatus, a request frame to request a second communication apparatus to perform a measurement on one or more links of the second communication apparatus, each of the one or more links being attached to one or more third communication apparatuses;
transmitting the request frame to the second communication apparatus; and
receiving a report frame from the second communication apparatus carrying one or more reports of the measurement respectively corresponding to the one or more links, wherein a frame body of the request frame is carried in a payload field of a first data frame, and a frame body of the report frame is carried in a payload field of a second data frame.
